(19) United States
(12) Patent Application Publication
(10) Pub. No.: US 2025/0190873 A1
(43) Pub. Date: Jun. 12, 2025

(54) System And Method For Verification And Auditing Of Intelligent Systems

(71) Applicant: University College Dublin, Dublin (IE)

(72) Inventors: Aditya KUPPA, Dublin (IE); Nhien-An LE-KHAC, Dublin (IE)

(21) Appl. No.: 18/974,727

(22) Filed: Dec. 9, 2024

Related U.S. Application Data
(60) Provisional application No. 63/607,551, filed on Dec. 7, 2023.

(51) Int. Cl. G06N 20/00

(52) U.S. Cl. CPC G06N 20/00

(57) ABSTRACT

This invention relates to a computer-implemented method and system for performing security evaluation on a machine learning (ML) model. The method includes determining a taxonomy of the ML model and of the environment in which the machine learning model is implemented at one or more stages in the model's lifecycle. The method additionally includes generating, based on the determined taxonomy, a set of assumptions about the ML model and the environment. An adversarial test attack is performed on the ML model at a stage in its lifecycle, based at least in part on the set of assumptions, and one or more failure modes in the ML model are identified based on the result of the first adversarial attack. The system may include a threat modelling component, an assessment component, a reporting component, and a risk mitigation component.

### CROSS REFERENCE TO RELATED APPLICATIONS

This application claims priority to U.S. Provisional Application No. 63/607,551, filed on Dec. 7, 2023, the entire disclosure of which is hereby incorporated by reference.

### BACKGROUND

The development of machine learning systems follows an iterative process defined as the Machine Learning (ML) life cycle. The accuracy and reliability of such Artificial Intelligence (AI)/ML model applications can be significantly improved, and the performance benefits enhanced, when the systems are robust. Existing approaches to threat modelling lack a holistic treatment of the assessment methodologies, metrics, and reporting models, and when addressing failure modes in ML systems, fail to account for the adversary view of all stages of the ML life cycle, meaning such ML systems are exposed to larger attack surfaces (the total number of possible points of entry for an unauthorised user to access a system or network, and extract or manipulate data). Furthermore, known adversary threat models and mitigation techniques are often incompatible with the stakeholder's goals, slowing down the defence process and rendering systems vulnerable.

Providing robust and secure real-world Machine Learning Systems in Cyber Security (MLSCS) is a multi-disciplinary task and requires an in-depth understanding of the machine learning life cycle, human-computer interaction, and the specific domain. To enhance reliable and accurate functionality, ML-based applications should be resilient to malicious attacks at all stages of the ML life cycle, and the models able to protect themselves from threats to the system's integrity, availability, and confidentiality security objectives.

Multiple steps are followed when designing real-world MLSCS—(a) problem understanding; (b) collection, cleaning, versioning, and management of relevant data; (c) feature and attribute extraction, feature engineering, and labelling; (d) model building which involves debugging, testing backed with interpretability, and explainable model outputs; and (e) continuous monitoring of the deployed system for performance degradation. MLSCS must be resilient to malicious attacks at all stages of the ML life cycle and protect themselves from the compromise of the system's confidentiality, integrity, and availability (CIA) security objectives. Existing deep learning attack surfaces mainly fall into three categories based on their effects on the “CIA triad”:
a. Privacy/Confidentiality: Information leakage threats such as membership inference attacks and model extraction attacks where adversaries manage to either recover data samples used in training or infer critical model parameters.
b. Integrity: Attacks that either mislead prediction outcome using maliciously crafted queries (i.e., adversarial inputs/examples) or through miss-training the model with poisoned training set (i.e., data poisoning attacks). For example, adversarial fault injection techniques, to attack Deep Neural Networks (DNN) acceleration in DNN-Field Programmable Gate Array (DNN-FPGA) systems, have been used to intentionally trigger weight noise to cause classification errors in a wide range of DL evaluation platforms.
c. Availability: Attacks which compromise the availability of a system may comprise overloading the systems with false data, which can significantly degrade the accuracy of an underlying detection system so that its functionalities are not available to legitimate users. Attacks to availability may also comprise logically corrupting the model weights or software components, to perform supply chain attacks and resource exhaustion. Similarly, corrupting the explanations produced by model to degrade their understanding by human analysts also falls under availability compromises.

The prior art does not provide a common framework to encompass all threats in system components and processes of the ML life cycle for cyber security operating in adversarial environments. Instead, current research is focused on representing the target environment at a very low resolution or are limited to one specific stage of the ML lifecycle. In addition, many of the proposed techniques are not applicable to comprehensive threat models, as they focus on specific malicious goals and specific levels of knowledge or capabilities available to the adversary. Many adversarial attacks have been proposed in the art, but most of these do not reflect real-life scenarios for MLSCS. For instance, testing black-box adversarial attacks, which can compromise the integrity, privacy, and availability of the underlying detection systems, while respecting the domain constraints, are rare.

Furthermore, studying the increase in the attack surface for an MLSCS in terms of Explainable Artificial Intelligence (XAIs) and adversary-induced concept drifts is sparsely found, and these threats are examined only in isolation with unrealistic threat models. The questions of how an attacker, given only outputs of explanation methods and model predictions, can conduct powerful black-box model extraction, and membership inference attacks, and how explanation outputs facilitate the generation of adversarial samples and poison/backdoor samples to evade the underlying classifier, remain largely unanswered. In addition, the designers of ML-based systems do not have a reliable way to quantitatively and continuously evaluate the integrity of the learned models against attacks. Doing so would be highly beneficial in terms of proactive defence against threats in the real world. In combatting adversaries, threat-centric, defence-centric, and policy-centric approaches are missing for MLSCS in the art. As a result, defenders often rely on ad hoc case-by-case mitigations which are incoherent with the stakeholder's goals, slowing down the defence process and rendering systems vulnerable.

Another factor for the successful adoption of MLSCS is how well domain experts and users can understand and trust their functionality. As these black-box MLSCS models are being employed to make important predictions, stakeholders would benefit from a greater transparency and explainability. Explanations supporting the output of ML models are crucial in cyber security, where experts require far more information from the model than a simple binary output for their analysis. Methods known in the art do not account for the security properties and threat models relevant to the cybersecurity domain, and attacks on explainable models in black box settings.

It would be beneficial to provide a framework to assist cyber security practitioners to model threats, addressing different types of adversarial scenarios, and to evaluate the system both at development and in production. Furthermore, it would be beneficial to provide the results of an evaluation and analysis to the users in an accessible and comprehensible form.

### SUMMARY

This Summary is intended to introduce, in an abbreviated form, various topics to be elaborated upon below in the Detailed Description. This Summary is not intended to identify key or essential aspects of the claimed invention. This Summary is similarly not intended for use as an aid in determining the scope of the claims.

According to a first aspect of the present disclosure, there is provided a computer-implemented method for performing security evaluation on a machine learning model. The method comprises determining a taxonomy of the machine learning model and of the environment in which the machine learning model is implemented at one or more stages in the model's lifecycle. In preferred embodiments, the taxonomy is of the machine learning model and of the environment in which the machine learning model is implemented at each stage of the model's lifecycle. Based on the determined taxonomy, a set of assumptions about the machine learning model and the environment is generated. A first adversarial test attack on the machine learning model at a stage in its lifecycle is then performed, based at least in part on the set of assumptions. One or more failure modes in the machine learning model are identified based on the result of the first adversarial attack.

Optionally, assessing the effect of the one or more failure modes on a subsequent stage in the machine learning model's lifecycle.

Optionally, determining the taxonomy comprises identifying one or more of the following: asset(s) associated with the machine learning model, one or more adversaries, one or more adversary goals, an attack specificity, an error specificity, an attack vector, an attack method, an attack phase, an adversary strategy, one or more resources available to the adversary, a level of access the adversary possesses, a level of knowledge the adversary possesses, a vulnerability of an asset associated with the machine learning model, and a defence mechanism of the machine learning model.

Optionally, the taxonomy comprises identifying a level of access the adversary possesses, and wherein the level of access is evaluated based on one or more of the following: a model or explanation access, a raw data access, a data collector access, a feature extraction and transformations function access, a model training data access, access to a similar model architecture, and a query-based access.

Optionally, the taxonomy comprises identifying a level of knowledge the adversary possesses, and wherein the level of knowledge is evaluated based on one or more of the following: a task knowledge, a platform knowledge, and knowledge of the machine learning model and/or the data used to build or train the model.

Optionally, generating the set of assumptions comprises mapping adversarial attack stages to one or more of: asset(s) associated with the machine learning model, a vulnerability of an asset associated with the machine learning model, an attack being in the inference or training phase of the machine learning model, a level of access the adversary possesses, and a level of knowledge the adversary possesses.

Optionally, the step of determining the taxonomy is performed by a threat modelling component that is trained on one or more of: data/deployment flow diagrams, machine learning models, data stores, stakeholders' security goals, and attack scenario catalogues.

Optionally, the determined threats are ranked based at least in part on the degree of their cascading impact on a subsequent stage or stages in the machine learning model's lifecycle and/or the presence of one or more compensating controls existing in relation to each of the said threats.

Optionally, generating the set of assumptions comprises identifying adversarial attack stages in terms of ML Adversarial Tactics, Techniques, and Common Knowledge (ATT&CK) techniques, and mapping the ML ATT&CK techniques to Common Vulnerabilities and Exposures (CVEs).

Optionally, mapping ATT&CK techniques to CVEs comprises computing a distance measurement between context representations in one or more CVE reports and concept representations of ATT&CK descriptions and generating a plurality of data labels for the mapping based on the computation.

Optionally, the method further comprises generating a report comprising information including the one or more failure modes in the machine learning model, the effect of the one or more failure modes on a further stage in the machine learning model's lifecycle, and/or an adversarial context.

Optionally, the method further comprises determining that the configuration of the machine learning model has been updated, and iterating the steps of determining, generating, performing, and identifying.

Optionally, the test attack performed at least in part based on the assumptions comprises an evasion attack, an inference attack, a poisoning attack on the training and/or testing dataset, or a model stealing attack.

Optionally, the method further comprises providing a notification at a user device in response to determining the presence of one or more failure modes in the machine learning model.

Optionally, the method further comprises performing remediation step(s) on one or more features or inputs of the ML model based on the identified failure mode(s).

Optionally, the method further comprises monitoring failure mode(s) over a period, identifying a pattern associated with one or more failure modes, and adjusting one or more parameters of the ML model based on the identified pattern.

According to a second aspect of the disclosure, there is provided computer readable media comprising instructions stored thereon which, when executed by one or more processors, cause the processor(s) to carry out the computer implemented method of performing security evaluation on the machine learning model.

According to a further aspect of the present disclosure there is provided a system for performing security evaluation on a machine learning model. The system comprises a threat modelling component configured to determine a taxonomy of the machine learning model and of the environment in which the machine learning model is implemented at one or more stages in the model's lifecycle. In preferred embodiments, the taxonomy is of the machine learning model and of the environment in which the machine learning model is implemented at each stage of the model's lifecycle. The threat modelling component may be configured to generate, based on the determined taxonomy, a set of assumptions about the machine learning model and the environment. The system further comprises an assessment component configured to perform a first adversarial test attack on the machine learning model at a stage in its lifecycle, based at least in part on the set of assumptions generated by the threat modelling component. The assessment component may be configured to identify one or more failure modes in the machine learning model based on the result of the first adversarial attack.

Optionally, the system further comprises a reporting component configured to generate a report comprising information including the one or more failure modes in the machine learning model, the effect of the one or more failure modes on a further stage in the machine learning model's lifecycle, and/or an adversarial context.

Optionally, the system further comprises a risk mitigation component configured to remediation step(s) on one or more features or inputs of the ML model based on the identified failure mode(s).

### BRIEF DESCRIPTION OF THE FIGURES

For a fuller understanding of the nature and objects of the disclosure, reference should be made to the following detailed description taken in conjunction with the accompanying drawings, in which:

FIG. 1 is a conceptual diagram illustrates four phases typically comprised in building Machine Learning Systems in Cyber Security (MLSCS), according to one or more implementations herein.

FIG. 2 is a conceptual box diagram illustrating a system, according to one or more implementations herein.

FIG. 3 is a box diagram illustrating a threat taxonomy, according to one or more implementations herein.

FIG. 4 is a box diagram illustrating classes and the relationships between the classes representing the ML Schema, according to one or more implementations herein.

FIG. 5 is a table depicting the mapping of two ML model attack scenarios to certain ATT&CK attack stages, according to one or more implementations herein.

FIG. 6 is a table depicting a mapping of different threat taxonomies according to the present disclosure against certain ATT&CK stages, according to one or more implementations herein.

FIG. 7 is a conceptual box diagram illustrating aspects of an assessment component, according to one or more implementations herein.

FIG. 8 is a conceptual box diagram illustrating the relationship between features of an attack module of the system with other components of the system, according to one or more implementations herein.

FIG. 9 illustrates an example report generated by a reporting module, according to one or more implementations herein.

FIG. 10 is a box diagram illustrating aspects of a risk mitigation component, according to one or more implementations herein.

FIG. 11 is a process diagram illustrating steps of an exemplary computer implemented method, according to one or more implementations herein.

FIG. 12 illustrates an aspect of a user interface application including interactive elements for configuring a threat modelling component, according to one or more implementations herein.

FIG. 13 shows an exemplary user interface displaying multiple different features and parameters of the exemplary system, according to one or more implementations herein.

FIG. 14 illustrates attack sample codes generated by the exemplary assessment component 200 to bypass an Adversarial Autoencoder-α (AAE-α) model, according to one or more implementations herein.

FIG. 15 illustrates an aspect of a user interface application including an AAE-α model, according to one or more implementations herein.

FIG. 16 illustrates a monitoring dashboard of a user interface application, according to one or more implementations herein.

FIG. 17 is a method, according to one or more implementations herein.

FIG. 18 is a method, according to one or more implementations herein.

FIG. 19 is a method, according to one or more implementations herein.

FIG. 20 is a diagram of example components of a device, according to one or more implementations herein.

FIG. 21 illustrates an artificial neural network (ANN), according to one or more implementations.

FIG. 22 illustrates a node, according to one or more implementations.

FIG. 23 illustrates a method of training a machine learning model of a machine learning module, according to one or more implementations.

FIG. 24 illustrates a method of analyzing input data using a machine learning module, according to one or more implementations.

### DETAILED DESCRIPTION

The present disclosure relates to a system and method for evaluating and securing Machine Learning (ML) models, particularly a computer-implemented method for performing cyber security evaluation on a machine learning model.

The present disclosure provides a computer implemented method and system to evaluate the security robustness of Machine Learning Systems in Cyber Security (MLSCS) under realistic threat models, covering all stages of ML life cycle, while respecting cyber security domain-specific constraints.

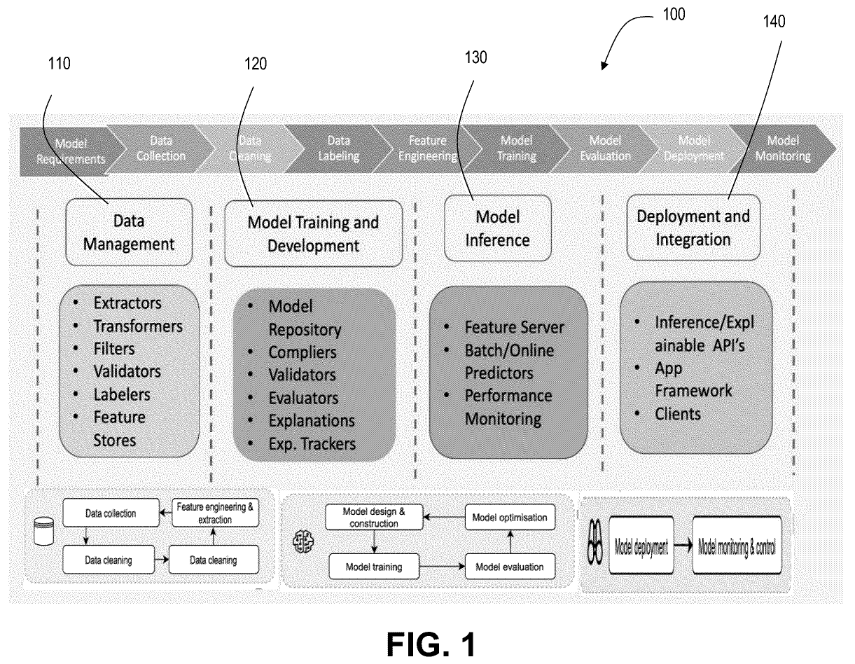

FIG. 1 is an exemplary diagram of four phases typically comprised in building MLSCS, or the MLSCS life cycle. The Data Management phase 110 typically comprises converting raw data into a form which is ready to train models. It comprises various components such as feature extractors, transformers, validators, annotators/labelers and feature stores. The Model Training and Development phase 120 may involve training the models, monitoring the training process, and tracking elements such as hyperparameters, data, and model performance. Often, iterative loops are used for model auditing and monitoring, which may result in re-training or implementing a collection of new data. Further, this phase may comprise preparing and compiling trained models for deployment to support relevant hardware targets and may also comprise securely storing for inference phase access, as described below. The Model Inference phase 130 may execute the trained models against input data, in batch and/or real-time, and monitors for any privacy, security, quality and robustness drops. The Deployment and Integration phase 140 deals with deployment of the model and developing interfaces to integrate the models and their outputs to the specific demands of clients and client applications, preferably while ensuring the security of the underlying model and data are preserved.

In the context of the cyber security domain, understanding the failure modes of each stage of the ML lifecycle, including how adversary influence at one stage propagates through the entire system, is instrumental in designing secure and robust ML systems. Adversary motivation is very high, and knowledge of this is relevant to understanding how the adversary may bypass mitigations. For example, an attacker can perform model-stealing attacks as ML models are shipped to endpoints where security is limited, and the adversary has real motivation to steal the models. In doing so, adversaries can understand the internals of the ML-based application, by-pass detection, and test the attacks offline, avoiding remote logging or alerting the owner. Similarly, little work is done to understand the security robustness of explainable methods with realistic threat models in the security domain—for instance, how an attacker can deceive both target classifiers and the explainable methods simultaneously, or perhaps manipulate only the explainable models while keeping the classifier's output similar or unchanged before and after the attack.

Finally, performing evasion and poisoning or back-door attacks on remote classifiers, help attackers to bypass detections and remain stealthy for longer times. Despite the fact that an attack on ML systems can cause harm to systems, enterprises, and the people dependent on them, industry practitioners today are not equipped with a holistic framework to analyze, detect, protect, and respond to these attacks on MLSCS. Motivated by the existing shortcomings discussed above, the present disclosure aims to provide a system and method for implementing an adversary and risk modelling framework, to help cyber defenders to targeting, intercepting and/or preventing present and future attacks and failure modes of the ML system in each stage of the development and deployment lifecycle.

In addition to the ambiguities around understanding risks by different stakeholders, e.g. Cyber security practitioners, ontology creators, and standardizing bodies, a unique challenge of the MLSCS relates to the increasingly complex systems and interactions underpinning security operations and modelling. Novel use cases, attack methodologies, defensive policies, and the sheer amount of available data, raise the question on how to ensure MLSCS integration with already existing information. The cyber security domain is inherently adversarial, defined by the state of the conflict between the adversary and the engineered environment it operates. Context is very dynamic, unpredictable, and be invalidated over time. Change is not only driven by adversary evolution but also by technological innovations and customer demands. A valid method at one point in time may not be valid at another.

Preferred embodiments of the computer-implemented method and system according to the present disclosure comprise one or more components which may be based on any of the following aspects of adversarial research in the context of cyber security:
1. Adversary Modelling—adversary modelling involves developing a representation of an adversarial relationship. A component of the present invention may form a model which captures the transparent interaction between the adversary, the environment and its defense capabilities.
2. Adversary Interactive—both attackers and defenders actively seek to gain control of the environment and modify it to their benefit. However, the entity that thoroughly understands the weakness and strengths of others can continue to maneuver around them successfully. The present invention preferably comprises a component that can help defenders to uncover and quantify known adversary tactics, preferably while respecting the constraints of adversary modelling.
3. Adversarial Mechanisms—these are organized activities that produce adversary-induced changes in a process with time. The interaction between the adversary and defenders will change the environment, since both are modifying the environment to impede each other. Understanding the dynamic nature of the environment and how change affects the overall goal of the adversary is useful for the Adversary Interactive component. The Adversarial Mechanisms component may comprise a sub-component of the Adversary Interactive component, which can help defenders to uncover and quantify known adversary tactics that are time-dependent.
4. Adversarial Validation—this is the process of observing and analyzing the adversary's actions and behavior and determining the causes of such behavior. For example, an adversary who learns the inner workings of a defense method can, in principle, seek to modify the state to invalidate that method. Explanations help in understanding the system state, perhaps in terms of the adversary, but any explanation in cyber security may be subject to invalidation by an adversary (as represented by Adversary Interactive) or the evolving environment (as represented by Adversarial Mechanisms). Adversarial Validation may comprise a sub-component of Adversary Interactive that can help defenders to uncover and quantify known adversary tactics that actively degrade explanations.
5. Adversarial State—this is defined by the measure of a capability and weakness of both adversary and defender in a given environment and time. This may provide a holistic view of each participant's goals: how they plan to achieve their goals, what risks are mitigated by the present controls, how much each side interprets the state of self, and conflicts in the environment. The present invention may comprise a component which can help defenders to quantify, mitigate and communicate risks of the environment based on adversary capabilities and resources.

The invention of the present disclosure may comprise one or more components based on these principles, configured to address the needs of stakeholders and users, such as practitioners, ontology designers, and standardizing bodies, by understanding and validating the security and robustness of MLSCS.

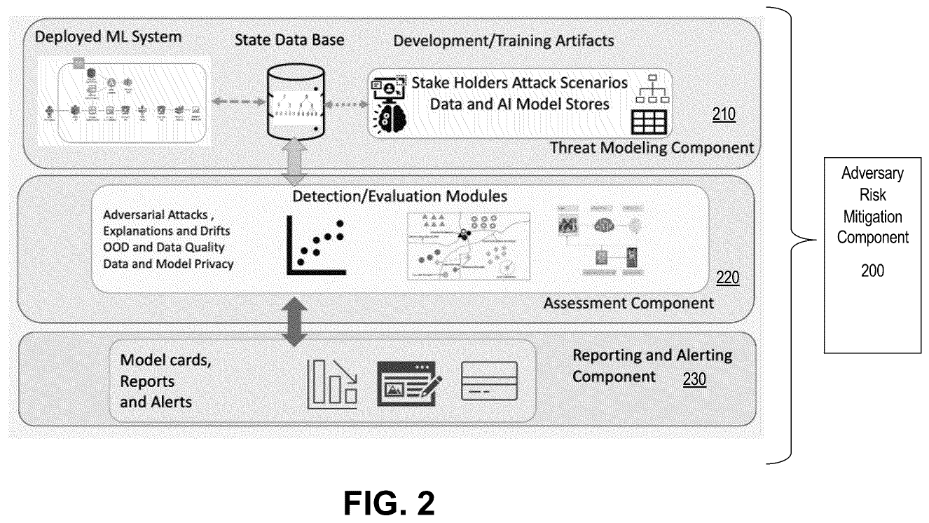

Referring to FIG. 2, there is illustrated a system including but not limited to a Threat Modelling Component 210, an Assessment Component 220, and a Reporting and Altering Component 230. Each of these components 210, 220, 230 interface with a risk mitigation component 200. It will be appreciated that each of the Threat Modelling Component 210, the Assessment Component 220, the Reporting and Altering Component 230, and the risk mitigation component 200 comprise one or a suite of software applications configured to execute the tasks outlined in the present disclosure. These components 210, 220, 230 may be executed by one or more processors, and instructions for performing their respective tasks may be stored in memory on appropriate computer readable media. They may be executed locally on a computer system, or remotely e.g. over a cloud network.

### I—Threat Modelling Component 210

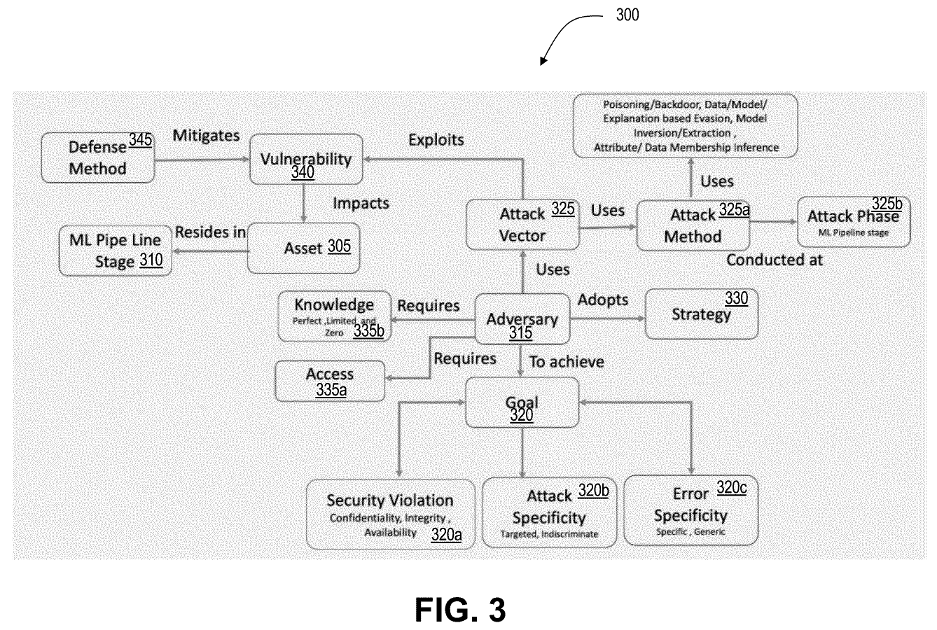

Preferred embodiments of the present disclosure comprise modelling, by the threat modelling component 210, the interaction between an adversary, and the domain or environmental context, including its defense capabilities, thus satisfying the Adversary Modelling aspect of adversarial research in the context of cyber security. In preferred embodiments, modelling the interaction between an adversary and the environment under attack comprises determining a taxonomy of the MLSCS and of the environment in which the model is implemented, preferably at each stage in the model's lifecycle. In order to meet this goal, one or more threat-modelling components 210 are configured to determine a threat model schema or threat taxonomy. The at least one threat-modelling component 210 may comprise a taxonomy of concepts and/or relationships, configured to identify assets, and understand multiple threat scenarios and assumptions, referred to herein as a “threat taxonomy”. FIG. 3 is an exemplary diagram of a threat taxonomy 300 according to embodiments of the present disclosure. FIG. 3 depicts some of the entities and relationships therebetween of the threat taxonomy 300. FIG. 3 depicts these relationships and entities at a high level of granularity, allowing the threat taxonomy 300 to be a basis for a broader spectrum of possible additions. In this regard, the formal characterization of specific threats, assets, adversaries, etc., can depend entirely on the ML use cases, their setup, and how the particular threat scenarios are usually defined. In preferred embodiments, the threat-modelling component 210 may be trained using any of data/deployment flow diagrams, ML models, data stores, stakeholders' security goals, and attack scenario catalogues as inputs, and may build the threat model definitions of the MLSCS. The training may comprise supervised or unsupervised learning techniques.

Entities of the taxonomy 300 may represent any of assets, adversaries, defenses (controls), vulnerabilities, and impact. In various embodiments, the threat taxonomy 300 may comprise one or more of the following: asset(s) associated with the machine learning model, one or more adversaries, one or more adversary goals, an attack specificity, an error specificity, an attack vector, an attack method, an attack phase, an adversary strategy, one or more resources available to the adversary, a level of access the adversary possesses, a level of knowledge the adversary possesses, a vulnerability of an asset associated with the machine learning model, and a defense mechanism of the ML model, as explained below.

A MLSCS comprises many processes, artefacts, and services. To represent these aspects, the threat taxonomy 300 may comprise one or more Asset entities 310. Any Asset entity 310 may reside in a particular ML pipeline or lifecycle stage 320. In preferred embodiments, the Asset entity 310 of the present invention may comprise any of the following high-level assets, or sub-entities (not illustrated):
Extractors [A1]: This sub-entity represents software artefacts responsible for selecting, parsing, and integrating data from the various data sources that exist in the system.
Validators and Filters [A2, A3]: This sub-entity represents software artefacts which are responsible for validating and filtering the data extracted by extractors and preventing the model from learning incorrect concepts.
Labelers [A4]: This sub-entity represents software artefacts or human annotators who are responsible for labelling the new data.
Feature Stores [A5]: a feature is an individual measurable property or characteristic of a phenomenon. The feature store(s) sub-entity represents a central hub to store curated features for machine learning pipelines.
Model Repository [A6]: This sub-entity represents a data store which hosts the models, their performance reports, versioning, and other configuration information (e.g., features used, hyperparameter values).
Model trainers and experiment trackers [A6, A7]: This sub-entity represents software and hardware responsible for training ML algorithms, which can include compilers, ML packages, and special-purpose hardware.
Model Evaluation and Validation [A8, A9]: This sub-entity represents systems responsible for evaluating and validating the trained model using various metrics on unseen offline/online datasets.
Model Explanations [A10]: This sub-entity represents models which are responsible for creating model explanations.
Model Serving and Integration [A11, A12]: This is responsible for deploying the model to provide predictions (e.g., using a REST API) and actively monitor model performance to detect performance degradation.

The threat taxonomy 300 may comprise one or more Adversary entities 315, representing an individual, group, system, or state responsible for an event or incident that impacts, or has the potential to impact, the security or safety of the MLSCS.

The threat taxonomy 10 may comprise one or more Adversary Goals 320, defined in terms of the attacker's aim to compromise the CIA properties of a system. The one or more Adversary Goals 320 may comprise any of the following security violations 320a:
Confidentiality [ADG-Conf]: An attack on confidentiality is to acquire private information of the dataset or the internal working of AI models, hyperparameters, features, etc. These attacks are generally part of the ‘reconnaissance’ stage of an adversary campaign.
Integrity [ADG-Int]: An attack on integrity is to modify the logic or to control the output of an AI model by interacting with the AI system. The complexity of attacks increases with confidence reduction, misclassification, targeted misclassification, and source-target misclassification.
Availability [ADG-Ava]: An adversary aims to disable the system's functionality to make the system unavailable or block regular use of an AI solution, which can be achieved by poisoning/back-dooring the data, corrupting the models, or tampering with the output.

The adversary goals 320 of the present disclosure may further comprise any of the following:
Attack Specificity 320b: An attack which may target a specific component/algorithm/architecture of the ML system or can be non-targeted attack against any component of MLSCS.
Error Specificity 320c: In the context of MLSCS, an attacker may aim to misclassify an input sample belonging to a specific class or to any of the classes different from the true class.

The threat taxonomy 300 of the present disclosure may further comprise any of the following entities:
Attack Vector 325: Potential violation of a security property by exploiting some type of vulnerability to conduct an attack. Vulnerability can exist in any/every phase of the ML pipeline. It can be exploited by different methods such as input manipulation, input extraction, training data manipulation, training data extraction, model manipulation, and model extraction.
Attack Method 325a: Algorithm or mechanism used to compromise the security property e.g., model inversion/extraction and attribute/data—membership inference attacks to downgrade Confidentiality property of the system, or data/model/explanation-based evasion attacks to diminish the Integrity and Availability properties of the system.
Attack Phase 325b: The stage of the ML pipeline or lifecycle at which the attack is performed—development phase (training, testing), deployment phase (inference time) or retraining phase, etc.
Strategy 330: The scheme used by an attacker to achieve his/her goal. Depending on the phase of attack (e.g., Training or Inference phase), an attacker can choose multiple strategies—to train a surrogate model for query reduction, parameter extraction, membership inference, etc. Similarly, the attacker can collect new/mirror data sets to craft attacks based on domain constraints.

The threat taxonomy 300 may further comprise one or more entities representing the Capability of an attacker, which may describe the resources available to the attacker. In preferred embodiments of the present disclosure, the capabilities of the attacker are divided into Access 335a capabilities and Knowledge 335b capabilities, as explained below.

In some embodiments, identifying a level of Access 335a the Adversary 315 possesses may be based on one or more of the following: model or explanation access, raw data access, data collector access, feature extraction and transformation's function access, model training data access, access to a similar model architecture, and query-based access. In some embodiments, the threat taxonomy 300 may comprise an Access entity 335a, representing the ability of an attacker to manipulate data, models, software, and hardware by reading confidential data, modifying or injecting new data or weights, and compromising third-party model/data/cloud providers. The Access entity 335a may comprise any of the following sub-entities to evaluate an attacker's access into the system (not shown):
Model/Explanation Access [ACA1, ACA2]: representing an adversary who has access to the exact explanation model and prediction model of the target MLSCS.
Raw Data Access [ACA3]: representing an adversary who has access to the raw data used to train the model.
Data Collector Access [ACA4]: representing an adversary with the ability to manipulate the data captured/measured at the data collection time.
Feature Extraction and Transformations Function Access [ACA5, ACA6, ACA7]: representing an adversary with access to various transformation and feature extraction functions.
Training/Labeled/Validation Data Access [ACA8, ACA9, ACA10]: representing an adversary who has access to training/labels/validation/test of the target model.
Auxiliary Data/Model Access [ACA11, ACA12]: representing an adversary 315 who has access to a dataset/model with a similar model architecture and data distribution to the training data used by the model.
Score-Based Query Access [ACA13]: representing an adversary 315 with the ability to query the trained model. The assumption is that the attacker has access to the probability vector, which describes confidence for each class. However, the adversary does not have access to the training data.
Decision-Based Query Access [ACA14]: representing an adversary 315 with the ability to query the trained model. The assumption is that the attacker has access only to the decision given a query. However, the adversary has no access to the probability vector or training data.
Explanation-Based Query Access [ACA15]: representing an adversary 315 with the ability to query the trained model. The attacker has access to an explanation report of the decision for a given query.
Prediction Access [ACA16]: representing an adversary 315 that has access to the outputs (predictions) of the model used in the target pipeline.

In some embodiments, identifying a level of knowledge the Adversary 315 possesses may be based on one or more of the following: a task knowledge, a platform knowledge, and knowledge of the machine learning model and/or the data used to build or train the model. The taxonomy 300 of the threat-modelling component 210 may comprise a knowledge class 335b, which may define attacker knowledge in terms of box attacks (black, white, grey, and no-box attacks) based on the attacker knowledge of the model, data, and so on. The knowledge class 335b may further comprise a set of parameters based on which the attacker's knowledge can be evaluated. These parameters may take the form of any of the following sub-entities (not illustrated):
Task Knowledge [ACK1]: representing an adversary that has general knowledge of the ML task, including the type of inputs and outputs.
Platform Knowledge [ACK2]: representing an adversary that has full/partial knowledge of the software platform used by MLSCS, including the inference and explanation interfaces, inputs formats, hosting details, software stack, access controls, model and feature stores, and build pipelines.
Explanation model Knowledge [ACK3]: representing an adversary that has full/partial knowledge of the explanation methods used MLSCS and interpretability and debugging and error messages exposed to developers.
Auxiliary models Knowledge [ACK4]: representing an adversary that has full/partial knowledge of the auxiliary models, and their settings used for defense, drifts, outlier, and filtering in MLSCS
Threshold Knowledge [ACK5]: representing an adversary that has full/partial knowledge of what thresholds parameters by MLSCS to arrive at a decision.
Model/Hyperparameter Knowledge [ACK6, ACK7]: representing an adversary that knows the model and its version used MLSCS production systems with their hyperparameters (number of epochs used to train the model, selected learning rate, etc.)
Raw Data Knowledge [ACK8]: representing an adversary that knows the exact data used for training the model but is not aware of the precise feature transformations applied to the raw data.
Feature Vector, Extraction and Transformations Knowledge [ACK9, ACK10, ACK11]: representing an adversary that knows the same feature used in building the model and how these features are extracted with the transformations functions to train the model.
Training Data Knowledge [ACK12]: representing an adversary that knows all/part of the training data used for training the model (including feature Vector, extraction, transformations, and filtering thresholds).
Data Property Knowledge [ACK13]: representing an adversary that understands the various statistical properties/distributions/filtering/imputation methods of the train data used by model.
Algorithm Knowledge [ACK14]: representing an adversary that knows the algorithm used to train the model but does not know the exact hyperparameters.

The taxonomy 300 may further comprise a Vulnerability class 340, which can represent a characteristic of an asset or a technology that may render them prone to an attack. In the context of MLSCS attacks, vulnerability can exist in software/hardware stack(s), which are traditional weaknesses in software systems, at which an attacker can manipulate the data and/or model, and cause CIA degradation. From the attacker's view, vulnerabilities in the system are used to exploit the system and achieve the attacker's goal.

The taxonomy may further comprise a Defense Method class 345, which refers to different mechanisms that may defeat the attacks and mitigate the risks to the MLSCS.

Optionally, the threat taxonomy 10300 may be an extension of known schema. This means that more specific ontologies, designed for specific applications (such as the threat taxonomy for MLSCS), can be developed and aligned with existing ML ontologies (contained in the known schema), making them more accessible to users.

An example of a known schema is ML Schema, proposed by the W3C Machine Learning Schema Community Group, which is an ontology that provides a set of classes, properties, and restrictions for representing and interchanging information on machine learning algorithms, datasets, and experiments. ML Schema defines constructs such that data descriptions, ML algorithms, tasks, implementations, and executions form the basis for the specification of ontologies, databases, and Application Program Interfaces (APIs) for ML, providing a high-level standard to represent ML experiments in a concise, unambiguous and computationally-processable manner. In other words, ML Schema aims to align existing ML ontologies and to support the development of more specific ontologies for particular purposes and applications. ML Schema can be extended and specialized, allowing to map other more domain-specific ontologies.

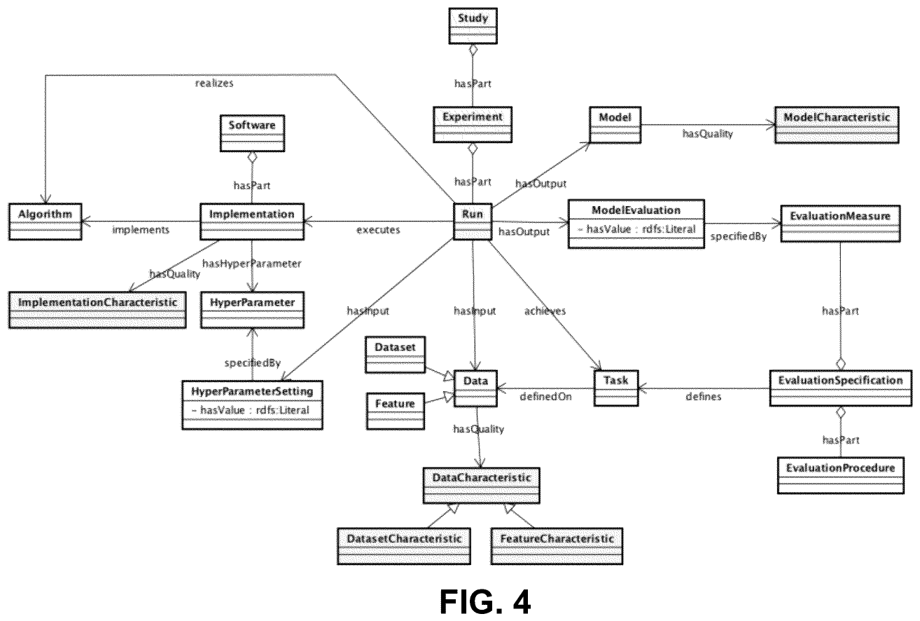

ML Schema includes representations of data, datasets, data/dataset characteristics, algorithms, parameters, software implementations, models architectures, evaluation metrics, and experiments details with different granularity. FIG. 4, the classes and the relationships between the classes representing the ML-Schema are depicted.

In general, the ML-Schema vocabulary contains representations of three categories of entities observed in the domain of machine learning experimentation: process entities, quality entities, and information entities. Examples of process entities include Run, Experiment, and Study, which form a taxonomy: one study can have experiments as parts, and one experiment can have runs as parts. i.e., study is the highest level of granularity representing collections of experiments. Examples of quality entities include data characteristic, dataset characteristic, feature characteristic, model characteristic, and implementation characteristic. Examples of information entities include task, data, dataset, feature, algorithm, implementation, software, hyper-parameter, hyper-parameter setting, model, model evaluation, evaluation measure, evaluation specification, and evaluation procedure.

The ML Schema does not cover threat-specific concepts in its schema definitions. In preferred embodiments of the present disclosure, ML Schema is extended with the Adversary Modelling constructs. Preferably, ML schema is extended while accounting for a known framework which is accessible to stakeholders, users and developers in the field. In some embodiments, the U.S. National Institute of Standards and Technology (NIST) risk management framework is taken into consideration, which is used for evaluating enterprise security risks. Some of the new entities used to extend ML Schema may cover any of assets, adversaries, defenses (controls), vulnerabilities, and impact, as outlined above.

Referring back to FIG. 2, the entities of the threat taxonomy 300, and the relationships between them, help to understand the dependency of the assets in MLSCS, given an attack scenario. The threat modelling component 210 of FIG. 2 is preferably configured to decorate entities of the threat taxonomy 300 with context and threat properties which are specific to a particular attack scenario.

In advantageous embodiments, the threat taxonomy 300 may be used to define a set of assumptions and/or connections between components/entities of the MLSCS, environment, and adversary, and reflect the defender and attacker visibility into the analyzed system. Generating the set of assumptions and/or connections may comprise mapping ‘adversarial attack stages’ to one or more of the entities of the threat taxonomy 300 like asset(s) associated with the ML model, vulnerability of an asset associated with the ML model, an attack being in the inference or training phase of the ML model, the level of access the adversary possesses, and the level of knowledge the adversary possesses.

By mapping the entities of the threat taxonomy 300 with pre-existing adversary stage taxonomies, stakeholders may describe the adversary view of the system using a common vocabulary, making adversary techniques and the victim ML systems more easily accessible and comprehensible to users and stakeholders. This also means that specific attack scenario parameters can be easily implemented. A number of pre-existing taxonomies and enumerations for describing core terms and concepts in cyber security may be used. For instance, Common Vulnerabilities and Exposures (CVE), Common Weakness Enumeration (CWE), Common Vulnerability Scoring System (CVSS), Common Attack Pattern Enumeration and Configuration (CAPEC), and a knowledge base of tactics and techniques used in the attack chain, called ATT&CK. These standards focus on capturing detailed information about vulnerabilities and threat information, which can be used in measuring and managing risk. Risk quantification and attack surface quantification are typically based over a set of assumptions that describe the system under examination, its controls, the threat landscape and/or the assumed capabilities and possible starting points of an adversary. While security taxonomies provide a good set of standards, and threat and vulnerability management data, it is still necessary to accurately model both the capabilities of controls—i.e., whether a control covers a threat/CVE—and factors deriving risk that account for an organization's risk profile and tolerance.

Mapping entities of a threat taxonomy to adversary tactics and techniques helps to better understand security risks from the point of view of stakeholders. As an example, one might consider an inference engine as the entity for mapping. The inference engine is a critical ML pipeline component; it exposes public interfaces or APIs that interact with external systems. The public APIs become potential entry points for lateral movement which attackers could use to pivot through the organization. This maps to the “Lateral Movement” tactic in adversary stage taxonomies. In light of this mapping, stakeholders can clearly articulate risks, for example “Prevent lateral movement through ML system interfaces”. This creates a shared vocabulary between security teams and ML engineers and makes risk assessment more concrete and actionable. Data access points could also be mapped to exfiltration risks, and model access could be mapped to tampering attempts. This mapping approach helps to create clear communication channels between technical and non-technical stakeholders, define specific security requirements and controls, prioritize security measures based on identified attack paths, and develop more comprehensive threat models.

In another example of taxonomy mapping between different stakeholders, an adversary stage taxonomy entity such as model probing might be mapped to multiple stakeholders including ML engineers, security teams, business personnel, and Dev-ops teams:
1. ML Engineers
   Technique ID: ML.001 Model Probing
   Their Language: “Inference endpoint anomalies”
   Common Term: “Model Interface Querying”
   Action Items: Monitor model serving patterns
2. Security Teams
   Technique ID: ML.001 Model Probing
   Their Language: “Reconnaissance activity”
   Common Term: “Model Interface Querying”
   Action Items: Detect unusual API patterns
3. Business Stakeholders
   Technique ID: ML.001 Model Probing
   Their Language: “Service abuse”
   Common Term: “Model Interface Querying”
   Action Items: Risk assessment and resource allocation
4. DevOps Teams
   Technique ID: ML.001 Model Probing
   Their Language: “API load anomalies”
   Common Term: “Model Interface Querying”
   Action Items: Infrastructure monitoring
Cross-Team Communication Example
   Incident Report Structure:
   Technique ID: ML.001
   Common Name: Model Interface Querying
   Impact per Stakeholder:
   ML: Model performance degradation
   Security: Potential extraction attempt
   Business: Service cost increase
   DevOps: Resource utilization spike

In preferred embodiments, ML-specific attack scenarios are defined in terms of the ATT&CK taxonomy, however, any suitable taxonomy may be implemented. ATT&CK is a globally-accessible knowledge base of adversary tactics and techniques which are based on real-world observations, i.e., the ATT&CK taxonomy outlays adversaries' tactics and techniques and information about known methods used by named attackers. The ATT&CK knowledge base may be used as a foundation for the development of specific threat models and methodologies. ATT&CK techniques are part of the ATT&CK framework that categorize the methods and tactics used by adversaries in various stages of cyber-attacks. The techniques listed in the ATT&CK framework are categorized into particular tactics, some of which include:
Reconnaissance: gathering information to plan future adversary operations, i.e., information about the target organization
Resource Development: establishing resources to support operations, i.e., setting up command and control infrastructure
Initial Access: trying to get into your network, i.e., spear phishing
Execution: trying the run malicious code, i.e., running a remote access tool
Persistence: trying to maintain their foothold, i.e., changing configurations
Privilege Escalation: trying to gain higher-level permissions, i.e., leveraging a vulnerability to elevate access
Defense Evasion: trying to avoid being detected, i.e., using trusted processes to hide malware
Credential Access: stealing accounts names and passwords, i.e., keylogging
Discovery: trying to figure out your environment, i.e., exploring what they can control
Lateral Movement: moving through your environment, i.e., using legitimate credentials to pivot through multiple systems
Collection: gathering data of interest to the adversary goal, i.e., accessing data in cloud storage
Command and Control: communicating with compromised systems to control them, i.e., mimicking normal web traffic to communicate with a victim network
Exfiltration: stealing data, i.e., transfer data to cloud account
Impact: manipulate, interrupt, or destroy systems and data, i.e., encrypting data with ransomware

Quantifying risks or threats in terms of the ATT&CK techniques and tactics helps stakeholders such as vulnerability managers and information security officers to measure risks of various components of the ML lifecycle.

The components and processes related to data, the model, and software may introduce weaknesses into the MLSCS. For example, they may arise in sensors that collect the data, the data processing component, the runtime monitoring tools, or the model itself. In embodiments of the present invention, the weaknesses of any or both software and ML components of the environment under attack may be tagged with ATT&CK attack stages, which means a holistic view of all the potential attack surfaces of all the assets in the MLSCS can be captured. By defining specific attack scenarios in terms of the ATT&CK taxonomy, both software- and ML-based weaknesses can share the same taxonomy.

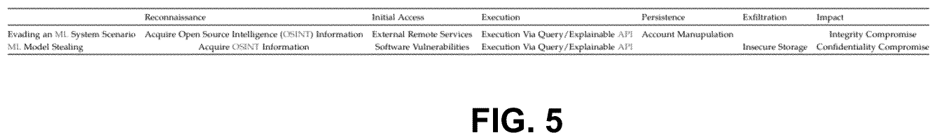

FIG. 5 depicts the mapping of two attack scenarios to some of the ATT&CK attack stages. In one attack scenario, for example, to perform an ML model-stealing attack, the attacker has to leverage publicly-available information, or Open-Source Intelligence (OSINT), about the organization to identify where or how machine learning is being used in a system, and to tailor an attack to make it more effective. Next, the attacker may exploit a weakness in one of the assets to gain access to internal model inference services. Finally, the attacker may execute a query-based attack to compromise the confidentiality property of the MLSCS. The tactics involved for an attack scenario are enumerated, each affected entity with the potential CIA impact is annotated.

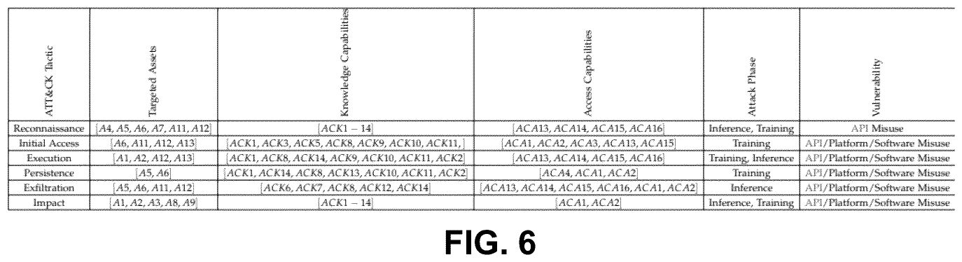

FIG. 6 summarizes the entity level mapping to some of the ATT&CK stages outlined above for generating a set of assumptions—the set of assumptions comprises mapping adversarial attack stages to one or more of: asset(s) 305 associated with the machine learning model, a vulnerability 340 of an asset 305 associated with the ML model, an attack being in the inference or training phase of the ML model, a level of access 335a the adversary 315 possesses, and a level of knowledge 335b the adversary 315 possesses.

The threat-specific conceptual representations of MLSCS of the threat-modelling component 210 in FIG. 2 help to create threat model definitions which are specific to attack scenarios and retrieve the contextual entities that may be affected by particular adversary action. The entities with their relationships form a knowledge base, wherein the threat-modelling component of the present disclosure may store the entities and their relationships in a relational database (referred to herein as a “State Database”) which can be queried to retrieve a subset of the knowledge base for further analysis, where the retrieved entities are already represented with their relationships. This approach not only yields the possibility of retrieval of existing entities in the pipeline but also helps in dynamically updating whenever the system/adversary state changes. By way of example only, in some embodiments the State Database may be queried by the assessment component 220 or the threat-modelling component 210 periodically with a pre-defined frequency.

Prior art threat models for MLSCS focus on representing the target environment at a shallow resolution or limited to one specific stage of the ML life cycle, with special attention to a particular category of adversary's knowledge and capability. However, embodiments of the present disclosure make it possible to expand the scope of an adversary's definitions to a more extensive set of goals with tighter constraints reflecting the operational nature of the threat. The threat modelling component 210 of the present disclosure facilitates the creation of a unique standard to represent entities and concepts within a specific knowledge domain. With its help, domain experts can agree on a common language for the definition of terms and relationships, and it is a valuable tool for reasoning about relationships between its entities.

Improving security and reducing risk are two main concerns for most organizations deploying MLSCS today. The rise in the number of high-impact vulnerabilities in software and the complexity of underlying systems opens up an opportunity for an adversary to exploit the vulnerability to achieve their goals. It may not always be evident for defenders to discover “which” systems have “what” vulnerabilities and “how” attackers can exploit these vulnerable systems. The threat modelling component allows for the mapping the assets to specific attack scenarios. The results can then be assessed to determine weaknesses of the MLSCS assets specific to each stage of ML life cycle. However, for a holistic risk assessment and mitigation, one must also factor in the vulnerabilities in the software installed on the assets. The threat-modelling component 210 of the present disclosure may be extended to not only establish weaknesses in the MLSCS assets, but also in software used by the MLSCS.

In the threat taxonomy 300, the attack scenarios may be defined in terms in ATT&CK stages to determine the weaknesses in the MLSCS. However, in further embodiments of the present disclosure, a unified threat model may be devised, which combines ML-based weaknesses and software/stack-based vulnerabilities, such that if a vulnerability is discovered in software used by MLSCS, that risk is also factored into the threat modelling component. There is an increasing volume of vulnerabilities, expansion of the attack surface, and sophistication of attacks and attackers when software vulnerabilities in MLSCS are considered. Therefore, in some embodiments of the present disclosure, CVEs (Common Vulnerabilities and Exposures such as e.g., a loosely secured cloud storage system that allows attackers to access sensitive data) are linked to the attack stages taxonomy, such as ATT&CK. Threats which arise in both the MLSCS, and software components can then be assessed and prioritized in a unified fashion.

Once the CVEs are linked to ATT&CK techniques and tactics, a unified threat scoring system can be designed holistically for the entire MLSCS lifecycle. CVSS is a score assigned to the characteristics and severity of a vulnerability, ranging from 0 to 10. Based on the magnitude of the score, each vulnerability may be categorized as None, Low, Medium, High, and Critical within the qualitative rating scale. There are three main metric groups in CVSS: base metrics, temporal metrics, and environmental metrics: Base metrics are needed to calculate the CVSS score. Temporal and environmental metrics are optional. Users may use any available information to update the score according to any changes in the model code's exploit maturity or effects on their organization. Base metrics capture the impact component of a CVE in terms of CIA. In the threat scoring system of the present disclosure, the inventors extracted the impact sub-score per CIA security goal for a given CVE and used it to calculate the overall threat score for an asset/entity in MLSCS. Similarly, the state database of the threat modeling component 210 is queried to retrieve the assets of the taxonomy 300 that may have been affected by a particular adversary action (e.g., ATT&CK technique) with their CIA specific compromises and individual assessment metric score. The threat scoring system adopted in certain embodiments of the presently disclosed system quantifies the assessment metrics in terms of how well the assets and related tasks contribute to the CIA security goals (confidentiality, integrity, availability) of the overall system. The assessment metric from evaluation modules of the exemplary system may be denoted as Eᵢⱼ and CVE related impact score Vᵢⱼ for an asset Aⱼ and security attribute T∈{C, I, A}, from which can be derived the unified threat score Sᵢ in terms of contributions towards T for each asset of the taxonomy based on the evaluation metric:

$${S}_{T}^{{A}_{j}} = \frac{{\sum }_{i = 1}^{n} {A}_{{j}_{T}} \times {S}_{{E}_{ij}}}{n} + \frac{{\sum }_{i = 1}^{n} {A}_{{j}_{T}} \times {S}_{{V}_{ij}}}{n}$$

where n is the number of assets.

Unified score US_{T} for security attribute T is calculated as a sum of the scores for all the assets:

$${US}_{T} = \frac{{\sum }_{j = 1}^{m} {S}_{T}^{{A}_{j}}}{m}$$

where m is the total number of assets under analysis in MLSCS.

Let us consider a simple MLSCS with three evaluation metrics, two assets that are part of the ATT&CK stage and two CVE's CVE₁₋₂ on one of the assets respectively to provide an overview of how the scoring works. The three evaluation metrics (E₁₋₃) and the impact scores of CVE₁₋₂ with their corresponding values on each asset are stated in Table 1.

TABLE 1
Evaluation factors' base weights used in example.

| ATT&CK Stage | |
|---|---|
| A₁ | A₂ |

| Evaluation Metric | C | I | A | C | I | A |
|---|---|---|---|---|---|---|
| E₁ | 0 | 0 | 4 | 0 | 0 | 2 |
| E₂ | 1 | 0 | 1 | 4 | 3 | 0 |
| E₃ | 1 | 0 | 2 | 2 | 2 | 0 |
| CVE₁ | 0 | 0 | 4 | 3 | 0 | 0 |
| CVE₂ | 0 | 0 | 3 | 1 | 4 | 0 |

Let us first look into the security properties of these assets to see how each of them contributes to the security triad:
A₁: has high scores on availability property across all the evaluation metrics. It is vital for the smooth running of the system, for example, a load balancer server. In addition, it has little impact on the confidentiality and integrity of the system as it is scored low by 3 metrics and has low CVSS scores.
A₂: it contributes all three properties of the security triad but is relatively scored weaker by E₂ and E₃ when looking at availability. On the other hand, confidentiality and integrity have high scores. For example, this can be some assets such as model/data store that need redundancy, strong authentication, and accountability.

This scoring system will help defenders focus the risk based on security properties. For example, suppose one aims to harden security based on all availability attributes. Then, it makes sense to fully implement mitigations on A₁, and if confidentiality and integrity are more important than availability, A₂ is a better choice for increasing controls.

Based on the scenarios enumerated in threat model taxonomy, and success and failure of evaluation modules of the adversary modelling framework according to preferred embodiments of the invention can score each threat scenario with threat score. The threat score discussed above has some limitations, e.g., it only scores threats that the exemplary system can validate/discover i.e. it is mostly a defender view of threats based on scenarios. One may also capture a holistic view of attacker actions and techniques in the wild to influence the score. For example, leveraging the already available environmental and temporal metrics of the CVSS score defender can re-prioritize their mitigation actions towards a given threat.

### II—Assessment Component 220

Returning to FIG. 2, the system may further comprise an Assessment Component 220 configured for utilizing the threat taxonomy developed by the threat modelling component 210 to identify security exposures for the ML model.

Cyber security is a rapidly-evolving field. Novel attacks emerge with technological advancements and new regulations, leading to an increase in attack surfaces for MLSCS. The present disclosure aims to provide a more complete spectrum of attack vectors that may compromise the integrity, privacy, and availability properties of the detection systems when assessing the security of MLSCS. The inventors have considered the novel attack surfaces for MLSCS system. For instance, interpretability and explainability have become an urgent need to MLSCS. Regulations such as the European Union's General Data Protection Regulation (GDPR) require interpretability when using AI algorithms. Explanations are exposed to end-users in most commercial systems. However, if attackers also understand these interpretations, they can more easily understand the principles behind prediction, construct malicious samples, and carry out targeted attacks. Similarly, real-world data collected in the cyber security domain is mostly observational, which can lead to an imbalance in the ground truth, and bias towards the sensor, labelling, and/or collection. Lack of ground truth, imbalanced datasets, and bias in dataset collection and labelling can help adversaries influence sources over time, opening up new attack surfaces.

The inventors have also considered the need for risk assessment and mitigation techniques to be threat/defense/policy-focused to provide effective resolutions for the relevant practitioners/end-users. In typical cyber security systems, once risks are identified, defenders may choose to prioritize, transfer, and manage risk depending on the technical, policy, legal, people, and budgetary constraints. In traditional software engineering, researchers design and seek a series of end-to-end measurements covering input/data/code/platform and interactions to discover failure modes. The inventors have developed a similar approach, with relevant metrics which capture the CIA properties of MLSCS, which may focus on adversarial scenarios. Also, risk management frameworks such as ISO 27001 and NIST SP 800-53 help organizations mitigate risk in information systems. These methodologies can be suitable for alleviating risks of MLSCS as the stakeholders' goals for traditional approaches and MLSCS remain the same.

Furthermore, it is important that MLSCS are secure and robust both at training time and deployment. Inability to detect security attacks, model performance, and robustness degradation over time can lead to stale models and increased technical debt. Whilst trained models usually come with security, robustness, and performance metrics on offline test sets, this does not guarantee similar performance in live systems.

Risk quantification and attack surface quantification can be based over a set of assumptions that describe the system under examination, its controls, the threat landscape and/or the assumed capabilities and possible starting points of an adversary. Preferred embodiments of the present invention may comprise one or more risk assessment components, configured to test, analyze and assess threats to the MLSCS based on any of the system's assumptions and state as determined by the threat taxonomy 10 of the threat modelling component. The risk assessment component may be configured to evaluate and priorities threats according to both impact and the compensating controls in place by a defender. Such a component may be based on at least the Adversary Interactive, Adversarial Mechanisms and Adversarial Validation properties of adversarial research in the context of cyber security and serves the needs of at least cyber security practitioners and standardizing bodies.

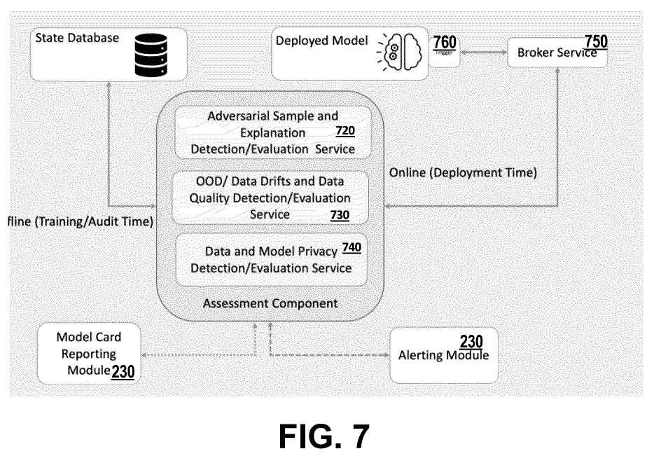

In preferred embodiments, the assessment component 220 of the present disclosure supports both training time and deployment time analysis of MLSCS. Assessments can be both offline (training/development time) and online (deployment time) modes. In offline mode, models are already trained and an external auditor or a stakeholder aims to understand the weakness of the system before it is deployed, so that they can perform a set of tests and enumerate the failure modes of the system. In online mode, the risk assessment component actively detect security violations, and may alert system users and analysts of malicious activity. FIG. 7 illustrates various assessment component 220 modules for development and deployment time analysis/monitoring.

### Assessment in Offline Mode

The input to the assessment component 220 may be a State Database 710 of the threat modelling component 210, which contains detailed threat properties of all the assets and their attack capability, preferably mapped to attack stages and relationships between them in the MLSCS. To be actionable to stakeholders, the output (i.e., the results and evidence) generated by the assessment component 220 may exhibit a set of fundamental properties important for evaluations.

The configuration files of the threat taxonomy 300, which define the data, model/feature stores, regulatory, and privacy requirements of the model deployment scenarios are queried from the State Database 710.

Queries (such as SQL-like queries) may be used to retrieve a subset of this knowledge base for further analysis. In such a way, one could search for entities individually or search the entire pipeline regarding their functionalities and metadata, i.e., any information referring to data and/or the model (e.g., execution log, parameter value, attack stage). In some embodiments, the State Database 710 may contain all the MLSCS assets with their relationships, which is continuously updated when the system changes. For example, each ML system component (models, data, pipelines) may be registered as an asset. Components typically store metadata such as execution logs, parameter values, and a current status. Relationships between components are explicitly tracked. Changes may then be timestamped and logged as events. Querying the system may take the following form:
SELECT * FROM ML_ASSET
WHERE metadata->>‘attack_stage’=‘inference_tampering’;
-- Track changes in last 24 hours
SELECT * FROM EVENTS
WHERE timestamp>NOW( )—INTERVAL ‘24 hours’;

The system may monitor for changes in the ML pipeline via events it consumes, with automated triggers updating the state database 701 in real time. Changes in relationships or metadata are logged.

For example, one possible query from the assessment component 220 to the State Database 710 could be to search for all assets that are part of the data management stage. The SQL query for this may take the following form:
SELECT asset WHERE MIPipelineStage contains DataManagement;
where MlPipelineStage labels the stage in the ML pipeline. DataManagement represents the entities of the ML pipeline or lifecycle which are responsible for data management 110.

However, such a query could result in a broad set of assets or entities. A filter to the above result can be applied on the dataset characteristics and attacker with training data access, to retrieve assets that are visible to an attacker with access capability. This may take the following form:
SELECT asset, model WHERE
MIPipelineStage contains DataManagement AND
Capability contains RawDataAccess;

This query facilitates access to parts of the ML pipeline that handle data, where someone with raw data access permissions could potentially access that data at high-risk points where data exposure is possible.

In both cases, the retrieved entities are already represented with their relationships. This approach not only yields the possibility of retrieval of existing entities in the pipeline but also helps in dynamically updating whenever the system/adversary state changes. Change events may be streamed to the state database of the threat modelling component 210 which listens to any change in the components and re-maps the threat based on changes.

Training time/offline assessments have the flexibility for developers and stakeholders to define the possible parameters of an attack such as perturbations, and their respective magnitude, privacy attacks (attribute vs property vs membership inferences), and bias and explainability requirements, to set up a real adversary. Then each scenario-dependent performance of the MLSCS against an adversary is systematically evaluated by running a set of evaluation tests or suites. This evaluation allows the integrity or robustness of ML models to be compared in different operational environments, meaning users can make well-founded decisions on whether an ML model of the MLSCS is fit for application. Once the evaluation is complete, a report may be generated that can be shared with internal/external auditors, stakeholders, and ML developers to improve the overall robustness of the MLSCS.

### Assessment in Online Mode

Deployment time (online) analysis and monitoring is conducted alongside the running models but must be done in a manner that does not adversely affect the performance of the ML model. It also depends on the type of user deployment (e.g., cloud vs on-premises), downstream users of the system, end-users (for example auditors/Chief Information Security Officer (CISO)/security analysts or ML or quality engineers), service level agreements (inference response, uptimes), and budgetary constraints. Incoming low latency requests can run as normal, with a payload logging solution sending events containing model request and response payloads to a broker 750 which can distribute these events out as desired via programmable triggers 760 to the modules of the serverless system of the assessment component 220, such as an outlier and drift modules 730, and adversarial detection module 720, to assess the MLSCS in real-time. The payload logging solution of the assessment component 220 may be configured to capture both input requests and model responses, record metadata such as timestamps and request IDs, and preserve the full payload for analysis. Further eventing APIs may be added to feed off the events produced by these APIs of the assessment component 220 to send onwards to, for example, alerting or visualization modules 230. The architecture provides a clean separation of concerns between the model and its later analysis components, each of which can be scaled separately. Moreover, the implementation of the payload logging solution facilitates real-time monitoring without impacting performance, comprehensive analysis of model behavior, early detection of issues or attacks in the ML lifecycle, and historical analysis and auditing.

The assessment component 220 may comprise several modules illustrated conceptually in FIG. 7, each supporting the evaluation/detection of different types of attack surfaces.

### Assessment

In some embodiments, the assessment component 200 may comprise one or more modules configured to test the MLSCS in a specific attack scenario, and support evaluation/detection of different types of attack surfaces, referred to herein as an Adversarial Attacks and Explanations Evaluation Module 720. Based on the threat model definitions, the present invention supports various attack methods at each MLSCS pipeline stage, which may include any of:
Evasion attacks compromise integrity and asset availability.
Inference attacks to compromise privacy/confidentiality of the assets residing in the pipeline.
Poisoning Attacks on training and testing dataset during model re-training or data collection phases.
Model Stealing attacks to compromise the privacy of the assets.

The attack method efficiency and defense method efficiency are typically measured by the level of negative impacts on an MLSCS system performance. In some embodiments, any combination of the following metrics (categorized into performance metrics, attack success metrics, and defense efficiency metrics) may be used for measuring the security and robustness of MLSCS in the Adversarial Attacks and Explanations Evaluation Module 720 of the assessment component 220:

### Performance Metrics:

Accuracy=(TP+TN)/(TP+FP+FN+TN): where TP and TN are True Positives and True Negatives respectively, and FP and FN are False Positives and False Negatives respectively. The accuracy represents the ratio of correctly predicted samples to the total samples;
Precision=TP/(TP+FP): represents the ratio of correctly predicted positive samples to the total predicted positive samples;
Recall=TP/(TP+FN): represents the ratio of correctly predicted positive samples to all positive samples; and
F1 score=2×(Recall×Precision)/(Recall+Precision): represents the weighted average of Precision and Recall that accounts for both false positives and false negatives.

### Attack Success Metrics:

Clean class accuracy per class: The percentage of the samples per class (e.g., “normal traffic”, “malicious traffic”, “bot traffic”) which are classified correctly by the model;
Adversarial accuracy per class: For both black and white box settings, it is defined as the percentage of adversarial examples per ground truth class successfully misclassified by the attack. This exposes the class boundaries weakness of the class. If multiple methods have high adversarial accuracy for a class, then any alerts on that class need more attention;
Adversarial average confidence per class: is defined by model average prediction confidence towards the non-ground truth class for an adversarial example;
True average confidence: is defined by model average prediction confidence towards the ground truth for an adversarial example;
Membership Inference Attack (MIA) Success Rate Attack: MIA attacks are when an adversary aims to infer any influence of the given sample in the target model training process. Typical MIA trains a set of surrogate models on a labelled set either via noisy real/proxy data or obtaining data from training distribution. Then attacker uses the surrogate model to train an attack model that helps to distinguish the participation of a data instance in the training set. True-positive and false-positive rates are measured; ideally, an attack should maximize the true-positive rate (many members are identified) while incurring a few false positives (incorrect membership guesses).
Model Stealing Success Accuracy: The functionality replication accuracy of the stolen model is measured, which is defined by the accuracy of the stolen model on the test set of the victim model.

### Defense Efficiency Metrics:—

Classification accuracy/confidence variance: is defined by a change in accuracy/confidence of the model on test data before or after a change in the system; and
Per class accuracy/confidence variance: is defined by the percentage change in accuracy/confidence of the model per class in test samples before or after a change in the system;

In some embodiments, the Adversarial Attack/Detection Module 720 may comprise one or more components configured to address at least one of the following properties:
Coverage [D1]—This property considers the ability of an attack/detection method to compromise/protect all/some CIA properties of the MLSCS system under investigation.
Complexity [D2]—This desideratum describes the attack/detection method in terms of the complexity of query and time. Query complexity is defined by the minimum q for which there exists a q bounded/budgeted adversary/defender that carries out a successful attack/detection and time complexity is the time taken for the attack/-detection method to converge. Low q attacks are harder to detect (fewer suspicious actions), whilst high q attacks may trigger security alerts.
Domain Constraints [D3]—These are a set of domain-specific constructs, rules which restrict the raw data sample transformation into feature space. They affect both attack and detection methods in similar fashion. For example, a user datagram protocol (UDP) packet flag cannot be manipulated/extracted from a transmission control protocol (TCP) flow. Also, the feature space is restricted to specific flags defined by the protocol specification, some features are more stable and essential for the system to produce correct predictions whereas some can be redundant. In summary, any adversarial attack generation method has to produce a realizable adversarial example in both the domain of operation and its feature space. A tangible robustness improvement can be achieved when domain constraints are respected, making the attack highly challenging for an adversary. Constraints can be defined by domain expert input or learning directly from data itself.

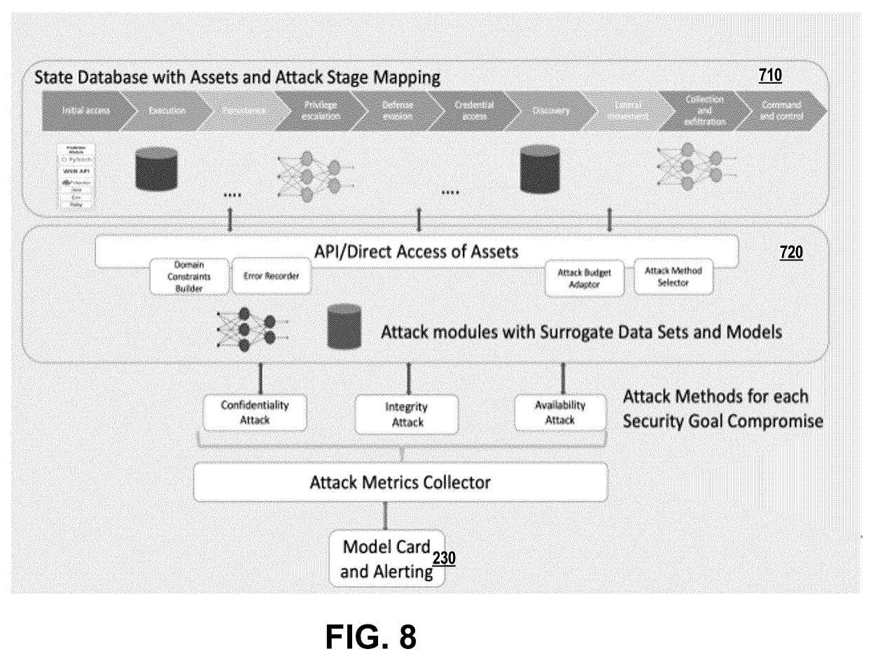

In preferred embodiments, the Adversarial Attack/Detection Module 720 may comprise at least one sub-module to satisfy the properties of [D1] to [D3]. FIG. 8 illustrates the Adversarial Attack module 720 of the assessment component 220, which may comprise one or more of the following sub-modules:
Attack Method Selector—There are many toolboxes that support configuring and running attacks for traditional MLSCS but selecting the right attack in a constraint threat definitions (black box) while satisfying domain constraints, is still a manual process, as the attacker does not know the defense mechanism of the target system. The Attack Method Selector sub-module is preferably configured to automate the process of selecting the right attack method for the threat model by generating an attack policy per adversary scenario from a collection of attack methods, and domain constraint transformation functions with minimal complexity. Given three attack methods, the attack selector module may be configured to build an attack policy which is a composition of a subset of attack methods and functions which are chained together and executed in a sequence, where the input of one attack method is fed into another to achieve the adversary's goal. Composing attacks in this fashion helps build strong attacks which are transferable from surrogate models and make the attack both effective and efficient.
Attack Budget Adaptor—Adversary attack budget is defined in terms of query and time complexity. The aim of the query reduction is to find the best attack policy. It has to choose the order in which the attack method is executed, and the domain transformation functions for each attack method. Given M attack methods and N functions, the total number of queries to be performed to find a suitable attack method and functions is expressed as ∥M∥^{N} In some embodiments, the NSGA-II algorithm may be used to reduce the querying process. This follows a 3-step strategy, namely, a population initialization step that is generating a population Po with random attack steps and function; an exploration step comprising crossover and mutation of an attack policy; and finally, an exploitation step that utilizes the hidden useful knowledge stored in the entire history of evaluated policies and find the optimal one.
Domain Constraints Builder—This sub-module may comprise a suite of functionality-preserving transformations functions which are specific to the type(s) of data the MLSCS processes.
Error Recorder—records any errors generated during the assessment process and raise an alert if it is preconfigured.

In preferred embodiments, the Adversarial Attack/Detection Module 720 is agnostic to the attack methods it uses to evaluate the MLSCS. The only criterion for any new attack method is that it must map to one or more of the CIA security goals of the adversary/defender. This satisfies the [D1]property and also keeps the framework of the present invention highly extensible.

In real-life MLSCS, different types of errors are generated which can provide useful information to attackers, depending on the threat model employed by the attacker. Errors can include configuration errors, system-generated errors, and run-time errors. Errors like system-generated and runtime errors may expose underlying defenses used by MLSCS, and help an attacker achieve their goal, or at least highlight the weakness to stakeholders. In preferred embodiments of the present invention, the Adversarial Attack/Detection Module 720 may comprise one or more sub-modules best presented in FIG. 8. The sub-module(s) of the Adversarial Attack/Detection Module 720 are preferably configured to record any errors generated during the assessment process, and raise an alert if it is pre-configured, namely utilizing the Error Recorder sub-module visible in FIG. 8.

A set of open datasets and ML/DNN models for each application type may be readily available in the assessment module 220 to bootstrap the evaluation process. Models with different architecture, weights, parameters, and training methodology help achieve higher attack transfer rates. For example, let us say the MLSCS is a phishing detection application—to bootstrap the attack, random sample(s) are selected from surrogate data that is collected from sources such as PhishTank, and using URL-Net as a surrogate model, attack samples can be generated for the model under evaluation. Below is the list of some open datasets available in surrogate dataset bank. The data from PaperWithCode1 website is scrapped for dataset mentions and models are downloaded into model bank. This is dependent on availability, licensing terms and size constraints of the model, but may include Phishing and URL Dataset(s), IDS Dataset(s), Malware Dataset(s), or other datasets.

Once an appropriate attack model(s) is selected by the attack method selector of the Adversarial Attack/Detection Module 720, it may be used to test the MLSCS at a particular stage of the lifecycle. The results of the testing can then be assessed.

In some embodiments, the Adversarial Attack/Detection Module 720 may be configured to support evaluating the quality of explanations produced by the ML model and may be configured based on one or more of the following properties.
Fidelity: The ability of the explanations to reflect the behavior of the prediction model;
Stability: The degree to which similar explanations are given for similar samples of the same class.
Representativity: The generalizability of the explanations, the extent to which the explanations are representative of the model and;
Consistency: The degree to which different models trained on the same task give the same explanation

First, several models ƒ^{O1}, . . . , ƒ^{Ok}, of the same architecture may be trained on different coalitions of (k−1) blocks (B) of data, such as Dᵢ=D\{Bᵢ} where D represents the complete dataset, Bᵢ (i=1 . . . k) are blocks of this data. Models with similar accuracy are considered for evaluation. Next, two multisets are prepared: G1, grouping the distances between explanations associated with the same prediction, and G2, the distances between explanations associated with different predictions. The distances between two explanations coming from different models may be measured and compared. Measuring the distance between explanations for a sample x between models trained on data—one which included sample x, and the other without it—provides the fidelity and stability explanation measures. By comparing the distance between prediction accuracy and explanations, the representativity and consistency of the model and data can be measured.

Real-world threat models to explainable APIs can be categorized into:
i. In a setting where explanations are legally required, manipulating the explanations may undermine the trustworthy evidence produced by these methods. In explanation manipulation attacks, a malicious model owner can leverage post-hoc explanation techniques to hide the weakness (fairness property) of the model and justify that the black-box model behaves fairly. Also, recent work has shown that explanations are sensitive to small perturbations of the input that do not change the classification result.
ii. An Adversary compromising the security of the underlying system by leveraging explanations exposed to the system. These methods include privacy compromises and evasion attacks. Privacy degradation attacks are further categorized into model extraction and membership/attribute inference attacks. Evasion attacks include the generation of adversarial examples and, data/model poisoning, and back-door injection techniques.

There are growing research efforts into methods to formally evaluate and compare explainers. In a recent survey, predictive accuracy, descriptive accuracy and relevancy (which is judged by humans) were proposed as three essential properties for evaluating explainers. Hall et al. [262] compiled a set of objective characteristics-effectiveness, versatility, constraints (i.e., privacy, computation cost, information collection effort) and the type of generated explanations without human evaluations. Metrics proposed by D. Alvarez Melis and T. Jaakkola, ‘Towards robust interpretability with self-explaining neural networks’, Advances in neural information processing systems, vol. 31, 2018 covers explicitness—intelligibility of explanations, faithfulness—feature relevance, and stability—consistency of explanations for similar or neighboring samples. Fidelity of explanations was evaluated by K. Yeh, C.-Y. Hsieh, A. Suggala, D. I. Inouye and P. K. Ravikumar, ‘On the (in) fidelity and sensitivity of explanations’, Advances in Neural Information Processing Systems, vol. 32, 2019 by quantifying the degree to which an explanation captures the underlying model changes. M. Yang and B. Kim, ‘Bim: Towards quantitative evaluation of interpretability methods with ground truth’, arXivpreprint arXiv:1907.09701, 2019 proposed three complementary metrics to evaluate explainers: model contrast score—comparing two models trained to consider opposite concepts as important, input dependence score—comparing one model with two inputs of different concepts, and input dependence rate—comparing one model with two functionally identical inputs. These metrics aim to specifically cover aspects of false-positives.

In the context of the security domain, the inventors have divided the explainability space into the following three dimensions which they have found advantageously permit a taxonomic modelling of XAI attack surfaces for the threat modelling component 210 of the exemplary system in FIG. 2:
(a) explanations of predictions/data itself X-PLA/N;
(b) explanations covering security and privacy properties of predictions/data XSP-PLAIN; and
(c) explanations covering threat model of predictions/data under consideration XT-PLAIN.

This X-PLAIN space covers the following type of explanations:
static vs. interactive changes in explanations seen by user in response to feedback.
local vs. global explanations.
in-model vs. post-hoc model explanations that cover models, which are transparent by their nature vs. use of an auxiliary method to explain a model after it has been trained.
surrogate model is a second, usually directly interpretable model that approximates a more complex model, while a visualization of a model may focus on parts of it and is not itself a full-fledged model.

The XSP-PLA/N space covers the following types of explanations:
Confidentiality properties of data and model e.g. which features of the data are protected by system owner.
Integrity properties of data and model e.g. when and how the data was collected, and model was trained to accommodate domain shifts etc. Fairness property can be part of model integrity in which explanations can help expose fairness violations by providing insights into possible biases in a model.
Privacy properties of data and model in the explanations e.g. which part of the data/-predictions is exposed to whom. For the publicly released training data and models, have noise added to them so that data rights or model privacy are not compromised.

Lastly, the XT-PLAIN space captures the properties of threat models considered at the time of training and deployment. e.g. data poisoning protection, thresholds used, etc.

Below is a non-exhaustive list of properties of XAI methods that are relevant to taxonomic threat modeling in the security domain by the threat modelling component 210:
Correctness: It is the measure of the explainer's ability to how accurately it identifies the input contribution to the prediction.
Consistency: It is the measure of the explainer's ability to capture the relevant components under various transformations to the input.
Transferability: How well does the explainer transfer the knowledge of the model it is trying to explain. Understanding the inner workings of a model facilitates the ability of a user/attacker to reuse this knowledge to craft an attack.
Confidence: The stability measure the explanations produced, which make their interpretations trustworthy [266].
Privacy: The side effect of explainability in ML models is its ability to assess/degrade privacy. The information revealed by ML techniques can be used both to generate more effective attacks in adversarial contexts aimed at confusing the model and develop techniques to better protect against private content exposure by using such information.

In some embodiments, the assessment component 200 of FIG. 8 may further comprise one or more Drifts Evaluation Module(s) modules 730, configured to support three major types of concept drifts generators and detectors, relevant for MLSCS:
Type A, Out-class evolution: drifting samples come from a new class that does not exist in the training dataset. As such, the originally trained classifier is not qualified to classify the drifting samples
Type B, in-class evolution: the drifting samples are still from the existing classes, but their behavior patterns are significantly different from those in the training dataset. In this case, the original classifier can easily make mistakes on these drifting samples.
Type C, Adversarial drifts: Injected samples by an adversary to damage the underlying drift classifier, these can come from the existing classes or new classes. In this case, the original classifier can make mistakes depending on the threat model of the adversary

Data drifts (changes in the distribution of the features an ML model receives in production, potentially causing a decline in model performance) observed in the cyber security domain are unique in nature, at least due to:
a. absence of timely feedback due to the scale of data—for example, manually labelling even 0.01% of web data (>1 million samples per day) will require analysts to work continuously for 8 hours;
b. drifts can be unknown and unbounded, e.g., due to random shifts in user/attacker behavior; and
c. new data may contain significant amounts of noise and may be irrelevant to the problem at hand.

To achieve better drift detection for Type A and B drifts, the Out-of-Distribution (OOD)/Data Drifts and Data Quality Detection/Evaluation Services 730 of the assessment component 220 may be configured with an objective “distance function” that supports instance-level fidelity (i.e., encouraging the samples of the same class to be as close as possible). In contrast, pairs of samples from different classes having a larger distance is needed. For example, in an image classifier model, the images of a first object such as a cat should be distinctly different from images of another object such as a dog. For adversarial drifts, the objective function has to be aware of group-level fidelity i.e., for a new incoming sample distribution, the distribution distances between all the samples of the same class should be minimum from the new input distribution. The inventors' motivation for the distance function comes from the properties of Adversarial subspaces: (a) compared to data manifold, they occur with a low probability; (b) class distributions generally vary from their closest data sub-manifold; (c) adversarial samples are found closer to nearest neighbor proximity to the unperturbed sample than to any other neighbor in the training or test set. Studies in this thesis leverage instance and group-level fidelity to generate drifts for adversary modelling.

### Drift Detection Metrics:

Performance: For drift detection, the F-score (the geometric mean of the precision and recall, which in turn rely on true positives (TP), false positives (FP), and false negatives (FN)) and;
Detection delay: which the average number of traces/events processed by the method between the actual drift and the moment the drift is detected by the method. It points out how early the approach can detect an actual change.

In preferred embodiments, the assessment component 220 may comprise one or more modules configured to evaluate the data quality and Out-of-Distribution (OOD), referred to herein as the OOD and Data/Feature Quality Evaluation Module 730. This module 730 may be configured to support various data quality and verification tests which gives model developers configuration-based flexibility to support different formats, extensibility to support new types, intervention to prevent the propagation of poor quality data to downstream jobs, and production system aspects including efficiency, automation, standardization, handling expected and sudden changes, deployment, scheduling, execution, availability, reliability, and monitoring of data quality. The OOD and Data/Feature Quality Evaluation Module 730 may be configured to support the following methods for data quality and OOD detection/evaluation:
Learning-based outlier detection methods: ML models are used to learn the statistical properties of the distributions of clean data to baseline and flag OOD and adversarial samples;
Error-detection methods: Hybrid models which combine rule-based systems with ML models to flag malformed samples;
For outlier detection for high dimension data, the OOD and Data/Feature Quality Evaluation Module 730 may be configured to support the following methods:
Deep Outlier Exposure
Ensemble of Leave-out Classifiers
Deep Mahalanobis Detector for calculating class-conditional outlier score from the deep features; and
OpenMax which uses mean activation vectors of ID classes observed during training followed by Weibull fitting to determine if a given sample is novel or OOD.

For outlier detection on tabular data, the OOD and Data/Feature Quality Evaluation Module 730 may use Autoencoder-based methods which rely on the reconstruction of the input to score instance outliers.

For data poison detection, an ensemble learning method called Bootstrap Aggregating (Bagging) may be applied. Given a training dataset, the bagging method first generates N subsamples by sampling from the training dataset with replacement uniformly at random, where each subsample includes k training examples. Then, bagging uses a base learning algorithm to train a base classifier on each subsample. Finally, given a testing example, bagging uses each base classifier to predict its label and takes a majority vote among the predicted labels as the final predicted label.

The OOD and Data/Feature Quality Evaluation Module 730 may use filtering-based techniques from outlier and data poisoning methods for adversarial sample detection, which remove suspicious samples during training based on training statistics. A metric may be employed to score each instance adversarial score concerning the model it was trained on to eliminate the adversarial samples, such as the Lipschitzian metric

The assessment component 220 may further comprise one or more Data/Model Privacy Violations Evaluation Modules 740. Neural Network models are good memorizers of training data. Irrespective of the method leveraged by the adversary to steal the model, the stolen models contain some direct or indirect information from the victim model's original data set. Model owners have full access to the training data on which model was trained vs. the attacker who has partial to no knowledge. Furthermore, model owners have a deeper understanding of the role of each data instance in the dataset with respect to training derived from the statistics arising from the behavior of the training procedure across each epoch. The Data/Model Privacy Violations Evaluation Modules 740 can take advantage of this information/knowledge asymmetry between attacker and model owner to design the remote audit method

To derive meaningful insights, one can observe how a training instance is trained across all epochs. In their recent work, S. Swayamdipta, R. Schwartz, N. Lourie, Y. Wang, H. Hajishirzi, N. A. Smith and Y. Choi, ‘Dataset cartography: Mapping and diagnosing datasets with training dynamics’, in Proceedings of the 2020 Conference on Empirical Methods in Natural Language Processing (EMNLP), 2020, pp. 9275-9293 proposed a set of metrics to understand data quality. Swayamdipta et al track each instance during training (training dynamics) for building data maps. For the verification scheme, the same metrics used to understand how the model has learned about a particular instance to derive a privacy score. Instances with high confidence and low variance are consistently predicted correctly by model. These are categorized as “easy” for the model. A low confidence and low variance instances are categorized as “noisy”, as they are seldom predicted correctly by the model. For samples with low confidence and high variance, the model is indecisive about these instances, making them challenging examples for the model. Training on challenging instances promotes generalization to OOD test sets, with little or no effect on In-distribution (ID) performance. Datasets contain a majority of easy instances, which are not as critical for In Distribution (ID) or OOD performance. Still, training could fail to converge without any such instances, and noisy instances frequently correspond to labelling errors.

The properties of training instances may be exploited to discover model stealing attacks in the framework. Furthermore, to avoid MIA-type attacks and unintentional leakage of sensitive attributes, in the system of the present disclosure, an instance level privacy score for training data is provided by the inventors. Given Xᵣ, Xₛ real and synthetic data sets generated by some generative algorithm Φ respectively, data is first converted into latent vectors in embedding space E(Xᵣ), E(Xₛ). Next, the spherelet distance is measured between each real and generated sample latent vectors. The spherelet distance between s(Xᵢ) and s(Xⱼ) is defined as:

$${d}_{S} = {d}_{R} ( {X}_{i} , {X}_{j} ) + {d}_{E} ( {X}_{i} , {X}_{j} )$$

where d_{E} is the Euclidean distance between two sets of points, and d_{R} is Riemannian divergence (geometric) of the datasets of Xᵢ and Xⱼ. The motivation behind this method is measuring the distance between points by projecting the samples on to a sphere centered at c with radius r. Spherelet of X denoted by s(X)=S(V, c, r) where V determines an affine subspace the sphere lies in. The spherical error of X is defined by

$$ϵ ( X ) = \frac{1}{n} {\sum }_{i = 1}^{n} {( ‖ {x}_{i} - c ‖ - r )}^{2}$$

If xᵢ lie on the sphere, then c(X)=0. The distance metric captures (a) which points are found in data manifold in low probability; (b) how close the synthetic and real in nearest neighbor proximity; which can give a proxy measure for over-fitting and data memorization.

The inventors have devised a Memorization Coefficient am for a generated sample X_{g}i, defined by gₙi/tₙi where tₙi and gₙi are sample counts from training and generated dataset, which have proximity distance less than a threshold>λ. The purpose of the synthetic generated dataset, preferably generated by the assessment component 220, is to assist in identifying training samples which may result in privacy leaks. Identifying such training samples improves model robustness around privacy attacks. The support set for the sample X_{g}i in the training and synthetic set is measured. Samples, which have αₘ<1 have large influence on the training set and are prone to MIA compared with samples where αₘ>1 capture the underlying distribution of training data without leaking private training set attributes.

One of the main reasons for privacy compromises in generative models is overfitting of training data which could lead to data memorization. To measure the unintentional leakage of sensitive attributes which leads to MIA, the present instance-level privacy score is devised for generated synthetic data from GAN using the memorization coefficient. The memorization coefficient αₘ is empirically measured by the assessment component 220 for each generated sample and this measure is used as a privacy score. Similarly, users can filter samples with high privacy scores and reduce privacy risks when distributing synthetic data to external third parties. Defenders can discard the samples that cross a certain threshold privacy score to protect users' privacy. Data audits by compliance bodies can be performed without a need to know the model internals and training dynamics. As one example use case of the Memorization Coefficient αₘ, the assessment component 220 may generate a synthetic patient record, e.g., “45 year old male, diabetes” and sets a similarity threshold A to find close matches. The assessment component 220 then counts similar records, e.g. sample counts from training and generated dataset are tₙi=4 and gₙi=2 respectively, giving a memorization coefficient αₘ=gₙi/tₙi=2/4=0.5. In this example case where αₘ<1 it can be inferred that the synthetic record is too similar to the model's data training, and therefore that the synthetic record was likely memorized from real patient data. The actionable recommendation in this example case would therefore be to filter these training data types for enhanced privacy. In some embodiments, the assessment component 220 may be configured with a user-facing API with one or more interactive display elements permitting a user to adjust a filter for αₘ, gₙi, tₙi or any other parameter associated with the memorization coefficient, or other attack specific configurations.

Existing risk assessment frameworks for the MLSCS system represent the target environment at a very low resolution, and miss the cascading view of a threat and its context. For example, the impact of manipulating an arbitrary file is not the same as manipulating a model's training data, since by manipulating a model's training data, the attacker can influence the model's decisions and by that, the attacker can extend the scope of the attack behind the specific host storing the training file. Known libraries which implement various ML attack techniques to evaluate the performance against the target ML model fail to quantify, or even ignore specific deployment of the target environment. Known frameworks, such as threat assessment and remediation analysis (TARA), among others are either predominantly manual and/or lack formal modelling. Therefore, the framework of the present invention aims to address that by both presenting a mathematical formalism and significantly improving the level of automation involved in MLSCS risk assessment.

The assessment component 220 supports offensive and defensive methods to continuously evaluate the security and robustness of MLSCS for each threat scenario. Furthermore, continuously tracking and evaluating the system state with the change of threat posture will benefit the practitioners.

### Reporting and Alerting Component 230

Referring again to FIG. 2, the system further comprises means, such as reporting component 230, configured to document any characteristics of the MLSCS, environment, and adversary, as produced by the risk assessment component, and format or condition these characteristics so they are easily comprehensible to relevant end-users. For instance, referring back to FIG. 7, the assessment component interfaces with the reporting component 230, which can document any of, for example, system objectives, the failure modes of each stage of the system, relevant metrics, and the functionality of the system, as far as these characteristics are deemed valuable. The reporting component 230 may condition this information on context, for standard bodies, auditors, and end-users. The reporting component 230 may produce a report which answers a series of questions specific to failure modes of the MLSCS, using the metrics derived from the assessment component 220. Preferably, the report generated by the reporting component 230 includes information concerning the mitigation status based on the stakeholder risk appetite and the organization's risk posture.

An aim of the reporting component 230 is to make the audit process usable, where the failure modes of data and/or models are communicated to end-users, with a view toward anticipating harms or potential impacts to stakeholders. It defines a contract between requirements and functionality of the system, which is deemed useful/harmful and is conditioned on context. For example, a model trained to classify malware samples into classes can reveal strong correlations between attributes for one of those classes, giving leads to research on causation between them, the model can perform strongly for samples that are similar to those in its training set, but poorly on those where some features were infrequent, even though the contract appears the same, but the context changed.

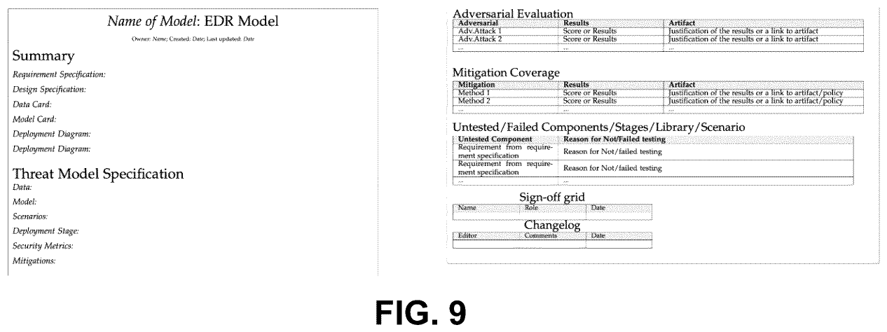

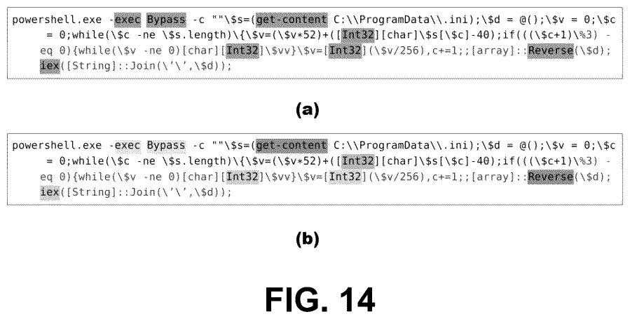

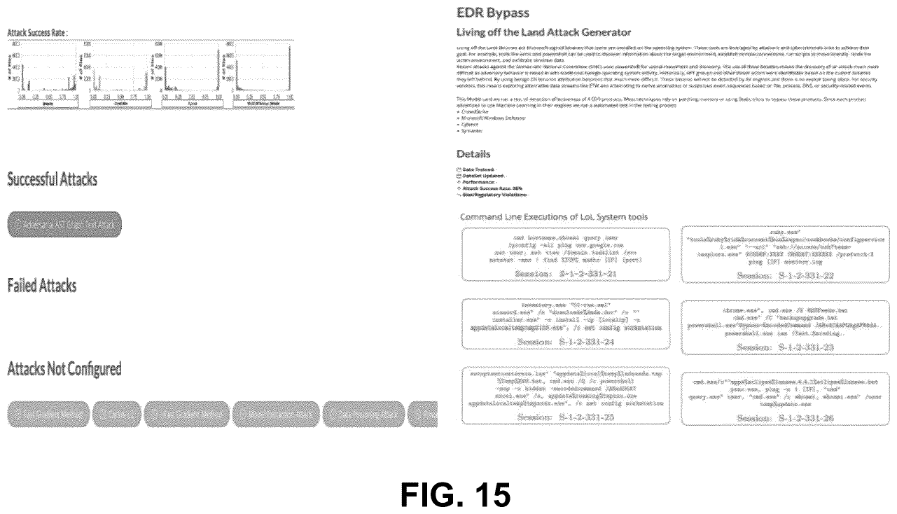

In some embodiments, the reporting component 230 may comprise an extension of known standardized documentation for communicating performance characteristics of trained AI models. Examples of such documentation are data statements, datasheets for datasets, model cards, reproducibility checklists, fairness checklists, and factsheets. Each has its own merits and requires different evaluation methods, answering questionnaires, and explanations. However, an explicit treatment of models trained with an active adversary in the environment is not well defined. In some embodiments, the datasheet standard (which answer questions related to when, where and how the training data was gathered etc.) and the model card standard may be extended to enable audit-based reporting, model cards and datasheets. FIG. 9 shows an example report generated by the reporting module 230, which contains model card and datasheets (data card), as well as threat specification information to answer a series of questions specific to adversarial scenarios, types of adversary and threat model the system is tested and its failure modes, continuous evaluation metrics of adversarial attacks, drifts, and explanations for both model and data. Furthermore, the report may include but is not limited to information concerning the mitigation status based on the stakeholder risk appetite and the organization's risk posture. Further examples of reports generated by the reporting component 230 are presented in FIGS. 14 and 15. It will be appreciated that the exemplary framework system illustrated in FIG. 2 may be configured to communicate with a user interface application which can be displayed on a user device, and which displays the report cards generated by the reporting component 230. Optionally, said user interface application may furthermore be configured with interactive elements including virtual buttons, sliders, drop-down menus and the like which permit a user of the device to configure aspects of the system in FIG. 2 and described elsewhere in the present disclosure, such as but not limited to the setup of the threat modelling component 210 and the assessment component 220.

By providing such information in this manner, the report can serve as a guide by communicating ML development and deployment information, including modelling assumptions, dataset biases, corner cases, etc., to stakeholders.

The reporting component 208 satisfies the Adversarial State aspect of adversarial research and provides accessible, readable information to serve at least the needs of ontology creators, standardizing bodies, and cyber security practitioners.

Referring again to FIG. 7, in some embodiments the assessment component 220 may interface with one or more alerting modules 210. The alerting module 210 may comprise a warning system that triggers an alert whenever risk metrics on the asset(s) of the MLSCS exceed by a non-negligible amount or crosses a predetermined threshold specified. For example, an alert may be raised when a new version of the model is deployed and a per class accuracy/confidence variance metric has decreased by a predefined threshold/set value. The warning may comprise a visual and/or audio notification provided directly or indirectly to one or more user devices such as a mobile device, a computer, or a laptop.

### IV—Risk Mitigation Component 200

Practitioners have to continuously make choices of what to protect in the MLSCS entities, and how to protect them. Assessments and decisions regarding priorities are facilitated and objectivized by using the regular risk assessment and mitigations practices. Research in adversarial ML has received extensive attention in image, text, and voice domains. However, adapting the same attack methodology to MLSCS may not succeed due to unique domain constraints and simple threat model assumptions. Thus, adversarial attacks that compromise the integrity, privacy, and availability of the underlying detection systems, which respect the domain constraints and real-world threat models, have not been duly considered in the art. Once risks are identified, defenders may choose to prioritize, transfer, and manage risk depending on the technical, policy, legal, people, and budgetary constraints, which is usually performed manually, fails to consider important factors, or is simply incapable of considering the sheer number of attacks surfaces of a complex ML system and correctly weighing relative risks, making it time-consuming and likely unreliable.

In preferred embodiments, the framework system of the present disclosure comprises one or more components configured to measure risk in terms of threats and their impact, at any stage of the ML lifecycle, referred to herein as a risk mitigation component 200, shown in FIGS. 2 and 9. The risk mitigation component 200 may be configured to consider any relevant factor, such as the threats (identified based on adversaries and their motives), defenses that help in combatting these threats, and any security policy/constraint, and. The risk mitigation component 200 can support the automatic prioritization of threats, tailored towards the organization's security goals. Furthermore, the risk mitigation component 200 may be configured to priorities these threats based on their cascading impact on the MLSCS or lifecycle thereof. The risk mitigation component may also provide detailed information on attack scenarios which are relevant and effective for MLSCS systems. Such a component 200 is highly beneficial to cyber security practitioners, as it significantly increases the efficiency with which, for example, critical security threats may be located and mitigated in a timely manner, and preferably, prevented in the future. Furthermore, such information can yield significant cost savings in terms of time, resources, effort, and money, as it can be easily determined what to protect, how to protect it and how to invest in security. This component aims to satisfy the Adversarial State component of adversarial research, measuring the capability of the attacker and defender for a particular environment, time, and/or stage in the lifecycle.

In preferred embodiments, the risk mitigation component 200 receives inputs from the threat modelling component 210 and/or the assessment component 220. By receiving inputs from the threat modelling component 210, either directly or indirectly (e.g., via the assessment component 220), the risks or threats have already been quantified in terms of the, e.g., ATT&CK techniques, tactics, and CVSS, assisting stakeholders (such as vulnerability managers, Information security officers) in measuring the risks of various components of the ML life.

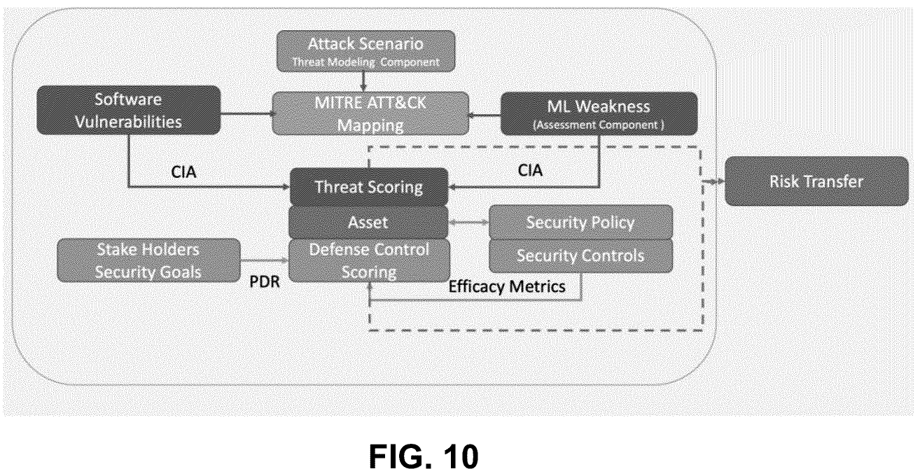

FIG. 10 conceptually illustrates various aspects of the risk mitigation component 200. In preferred embodiments, the risk mitigation component 200 may be configured with a unified threat scoring system 1010, such as the unified scoring system described earlier in relation to threat modelling component 210 with unified score U_{ST}, to quantify the assessment metrics and CVSS scores in terms of how well the assets and related tasks contribute to the CIA security goals of the overall system and prioritize risks in a holistic manner. The threat scores capture the severity in each dimension of {C, I, A}. Threat scores, for each asset, for a given threat scenario, can be generated based on the scenarios enumerated in the threat model taxonomy 10, and the success and failure of evaluation modules (202, 204, 206).

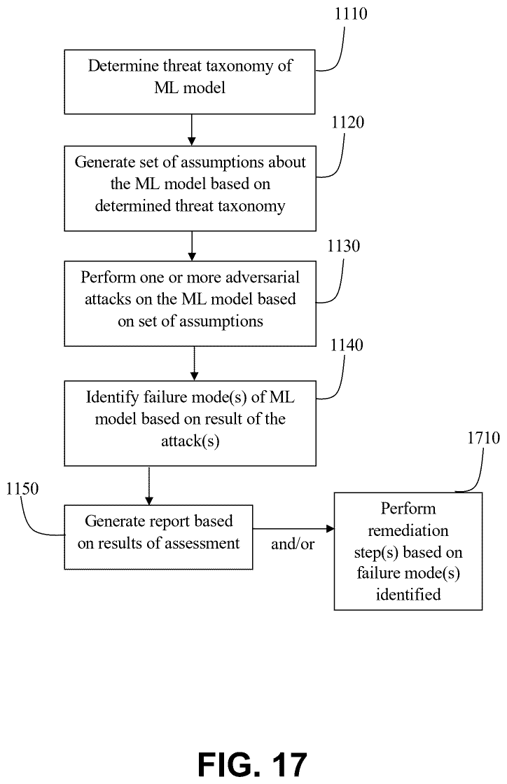

In preferred embodiments, the risk mitigation component 200 supports one or more mitigation techniques. In preferred embodiments, the risk mitigation component supports three mitigation techniques to reduce the adversary's risks in MLSCS. FIGS. 17-19 provide examples in which the risk mitigation component 200 is utilized for remediation steps after the assessment component 220 identifies one or more failure modes in an ML model.

In some embodiments, the risk mitigation component 200 supports a threat-centric method that quantifies risk in terms of the ATT&CK techniques, tactics, and CVSS which helps stakeholders such as vulnerability managers, Information security officers to measure risks of various components of the ML life cycle. In some embodiments, the risk mitigation component 200 supports a defense-centric scoring mechanism that helps analysts quantify the efficacy of security controls/defense methods and helps in re-assessing risk appetite of the MLSCS. In some embodiments, the risk mitigation component 200 may comprise a security policy-centric procedure enables the stakeholders to choose and tune the security policy of when/what type of security controls to be adapted based on security goals and risk transfer decisions.

In some embodiments, the risk mitigation component 200 comprises a system which is configured to execute a security policy-centric procedure, referred to herein as a security/defense control scoring system 1020. The defense scoring system 1020 may use risk vs trade-off values and may continuously measure the effectiveness of security controls against a given threat inside an organization, taking into consideration defender security goals {P, D, R}(protection, detection, and response). Organizations prioritize the defender actions based on security investments into people, processes, and controls. For example, suppose an organization has invested in incident response personnel. In that case, they may give more weightage to controls that help them respond to threats instead of detection, which may sometimes lead to alert fatigue, wasted response times, and conflicting results. The risk mitigation component 200 can run a set of causal inference methods using security/defense control scoring by the defense scoring system 1020 to help stakeholders decide on the security policy decisions.

Once the adversary actions are quantified in terms of threat score severity, control scores, and security policies which capture the stakeholders' risk appetite, defenders can now mitigate essential risks. Not all risks are essential and may not be managed by organizations due to budgetary constraints/legal reasons. The risk which is residual and not being addressed can be transferred to a third-party, for instance by mechanisms such as Cyber Insurance (CI). An example of CI that may be implemented with the present disclosure is the RiskWriter framework described by Aditya, K., Grzonkowski, S., Le-Khac, NA. (2018). ‘RiskWriter: Predicting Cyber Risk of an Enterprise’. In: Ganapathy, V., Jaeger, T., Shyamasundar, R. (eds) Information Systems Security. ICISS 2018. Lecture Notes in Computer Science, vol 11281. Springer, Cham. https://doi.org/10.1007/978-3-030-05171-6_5 which is incorporated herein by reference.

### Case Study

Implementation of the exemplary framework system in FIG. 2 including the risk mitigation component 200, the threat modelling component 210, the assessment component 220, and the reporting component 230 will now be described with reference to a case study in which the failure modes of a neural network model utilizing Adversarial Autoencoder (AAE-α) are analyzed. It will be appreciated that the present case study is provided merely as an example worked implementation of the invention of the present disclosure and is not intended to be limiting in any way. Adaptions could be made without departing from the scope of the disclosure. For example, the range of entities factored into the threat taxonomy.

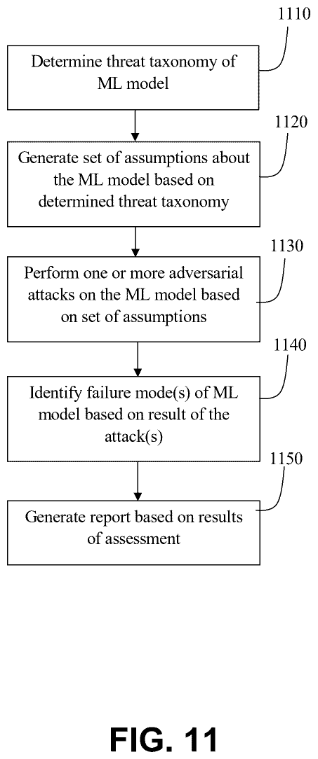

In a first step 1110 visible in FIG. 11, a threat taxonomy of the ML (neural network) model, such as the threat taxonomy in FIG. 3, is determined using the threat modelling component 210. Preferably, the threat taxonomy further encompasses the environment in which the ML model is deployed at one or more stages, preferably at each stage, in the model's lifecycle. Using the threat modelling component 210, the attack scenarios are enumerated in terms of the adversary objectives. This may be based on the CIA properties relevant to model operation both at training and deployment time. In a second step 1120, the threat modelling component 210 generates, based on the determined threat taxonomy in step 1110, a set of assumptions about the ML model and the environment in which it is deployed at each in its lifecycle. In the present case study, the threat modelling component 210 is configured in step 210 with attack metrics, domain constraints, and attacker access to external data to reflect a real-world attacker, based on the determined threat taxonomy. In a further step 1130, a number of security scenarios are assessed by the assessment component 220. Assessing security scenario(s) may include the assessment component 220 performing one or more adversarial attacks on the ML model at a stage in its lifecycle, based at least in part on the set of assumptions generated in step 1120. Subsequent to performing the one or more adversarial attacks, one or more failure modes of the ML model may be identified 1140 by the assessment component 220, based on the results of said attack(s). Subsequently, the effectiveness and success rates may optionally be reported 1150 by the reporting component 230 to help stakeholders and developers improve the system's robustness. The report may identify a number of key parameters and facts, including but not limited to successful attacks, failed attacks, details of the threat taxonomy utilized, details of assumptions generated based on the threat taxonomy, and actionable recommendations based on these information points. In preferred embodiments, the report generated by the reporting component 230 is pushed to a user device for review. In some embodiments, the report may be fed to and digested by one or more software components that are configured to action the results of the report. It will be understood that the step 1150 of reporting the findings of the assessment in 1110-1140 is optional and may be omitted from the method of FIG. 11.

The constraints on the attacker determined by the threat modelling component 210 in steps 1110-1120 in the case study were as follows:
Attack Asset Visibility gathered in a Reconnaissance Stage—[A11, A12]
Adversary Goal 320—[ADG-Int, ADG-Con ƒ, ADG-Aval]
Attack Specificity 320b—Indiscriminate attack
Error Specificity 320c—Generic attack
Attack Vector 325—Input Manipulation and Model extraction and when operated in the streaming setting, has an auxiliary drift detector used to detect drifts.
Attack Method 325a [AM]—Black box adversarial evasion, explanations, drift, model stealing, and membership inference attacks on the detector.
Attack Phase 325b [AP]—Development/Deployment Phase
Attack Strategy 330 [AS]—Training a surrogate model and using external data
Attacker Knowledge Capability 335b—[ACK1, ACK2, ACK4, ACK5, ACK8]
Attacker Access Capability 335a—[ACA13, ACA15, ACA16]
Vulnerability 340—ML-based
Defense Method 345—None
Metrics—Adversarial Accuracy Per class, which is measured by the ratio of samples that meets the adversary's goal for this example case study:

min Q(x) s.t. ƒ(x_{adv})≠yₜ

where Q(x) denotes the total number of queries needed for finding an adversarial example for seed sample x, yₜ represents the original label of instance x with threshold t, and x_{adv} refers to the adversarial instance.
Domain Constraints—The perturbation δ changing the original instance x into x_{adv}=x+δ should be executed without change in functionality and should be sparse and interpretable. Also, the distortion added should not create a malformed command line when features are transformed back to text.
External Data—The attacker can leverage external openly available datasets to execute the attack.

Some important aspects are provided in Table 2 specific to each adversary goal.

TABLE 2

| | | Model | | | |
|---|---|---|---|---|---|
| | | Extraction | | Poisoning | |
| | | Attack | | Attack | Adv. |
| | | (MEA) | MIA | (PA) | Ex |
| Characteristic | Type | [274] | [275] | [276] | [13] |
| Knowledge | Training | N | N | Y | N |
| | Distribution | | | | |
| | Feature Set | Y | Y | Y | Y |
| | Feature | Y | Y | Y | Y |
| | Extractor | | | | |
| | Feature | Y | Y | Y | Y |
| | Transformers | | | | |
| | Inference API | Y | Y | Y | Y |
| | Explanations | Y | Y | Y | Y |
| | interface/Method | | | | |
| | Confidence | Y | Y | Y | Y |
| | Intervals | | | | |
| Goal/Intent | Compromising | N | N | Y | Y |
| | Integrity | | | | |
| | (Evasion) | | | | |
| | Compromising | Y | Y | N | N |
| | Privacy | | | | |
| Capability | Manipulate | N | N | Y | N |
| | Training Data | | | | |
| | Manipulate Test | N | Y | N | Y |
| | Data | | | | |
| Strategy | Train a | N | Y | N | N |
| | Surrogate Model | | | | |
| | for Parameter | | | | |
| | Extraction | | | | |
| | Train a | Y | N | N | Y |
| | Surrogate Model | | | | |
| | for Query | | | | |
| | Reduction | | | | |
| | Satisfy Domain | N | Y | Y | Y |
| | Constraints | | | | |
| Frequency | Iterative | Y | Y | Y | Y |
| Perturbation | Instance | Y | Y | Y | Y |
| Scope | Specific | | | | |
| Perturbation | Optimization | Y | N | Y | N |
| Constraints | Domain | Y | Y | Y | Y |

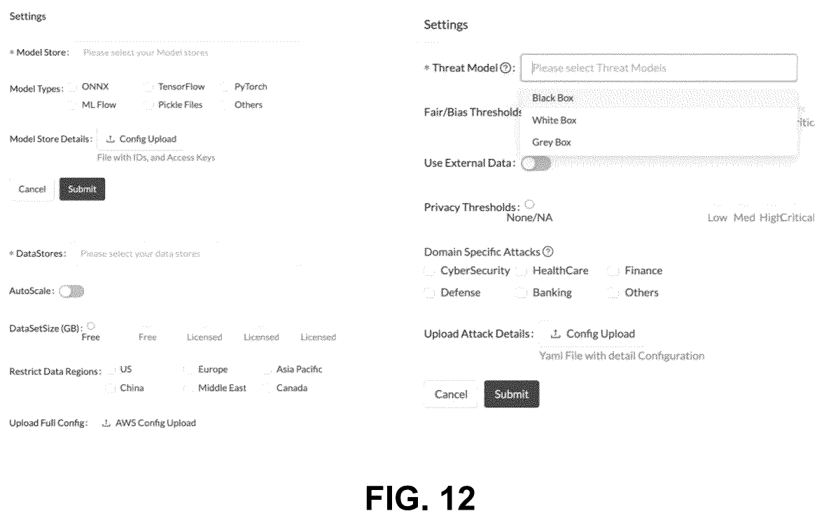

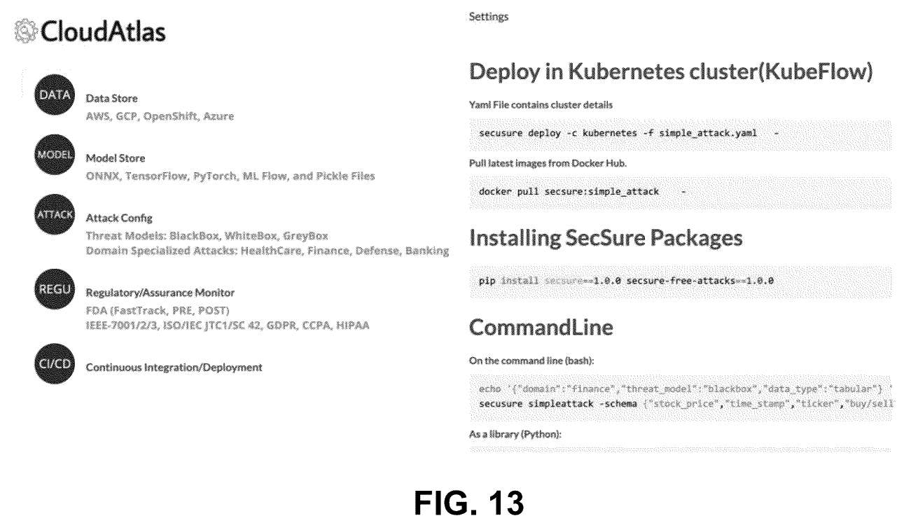

With these constraints in place, the exemplary adversary modelling framework, in particular the threat modelling component 210 of the framework, is configured to capture the threat model. FIG. 12 shows one aspect of an exemplary user interface with a threat modelling component 210 configuration setup. FIG. 13 shows the datastore, model configurations and monitoring interfaces of the exemplary user interface that the system of FIG. 2 is configured to communicate with. The framework illustrated in FIG. 2 may be configured to support multiple scenarios in black-box settings. In this example case study, 5 attacks were configured: Black box adversarial evasion, XAI, drift, model stealing, and membership inference attacks on MLSCS detectors. FIG. 14 illustrates attack samples generated by the assessment component 220 of the system to bypass the AAE-α model. The effectiveness of an attack is given by the objective function of the attack strategy. In FIG. 14 we see gradient explanations of attacker and administrator code executions of AAE-α for discovering targeted attacks (a) Command executions of attacker 1 (Classified by system as Malicious), (b) Adversarial explanation against the system (Classified by system as Benign and explanation map changed to benign).

To help solve domain constraints, the assessment component 220 of the system of FIG. 2 may be configured to selectively replace a small set of features instead of perturbing all of the features, and a PowerShell AST external data set is used to generate valid PowerShell commands for changed values keeping other properties intact. For explanations reports, the gradients contributed by each feature of the data point are analyzed. For example, given the trained AAE-α and an attacker command line, the gradient map between the feature and reconstruction error is used to explain a particular feature's contribution to the anomaly. For drift detectors, w_{S} (samples per streaming window) and w_{M} (model training time window) were fixed to 100 samples and 90 minutes respectively in this example. Given the trained AAE-α and an attacker command line, the drift detector generated 100 samples with a 90-minute-time window difference with 10% of adversarial examples in each window. PowerShell AST as a proxy dataset for model stealing attacks is used and a surrogate model is trained using the AutoML framework.

The results of security assessment are to be defined in terms of the adversary objectives and translated to high-level goals of the system and help the stakeholders understand and document the limitations of the proposed solution, assumptions under which the underlying system operates, and reasoning about multiple corner conditions which the system may miss. FIG. 15 illustrates the model for AAE-α and Table 3 below summarizes the results of all the attacks. In particular, Table 3 summarizes the attack Success Rate (ASR) for AAE-α and its Gradient based Interpreter and Model Stealing (accuracy of stolen model w.r.t to query count) n(100, 1000, 1000). ‘n’ was sampled randomly from all datasets and removed from the training set to reflect the real attacker.

TABLE 3

| n | MIA | MEA | Adv. Examples | Adv. Drifts | Adv.XAI |
|---|---|---|---|---|---|
| 100 | 0.76 | 0.65 | 0.56 | 0.44 | 0.21 |
| 1000 | 0.87 | 0.76 | 0.67 | 0.58 | 0.56 |
| 10000 | 0.99 | 0.98 | 0.99 | 0.97 | 0.98 |

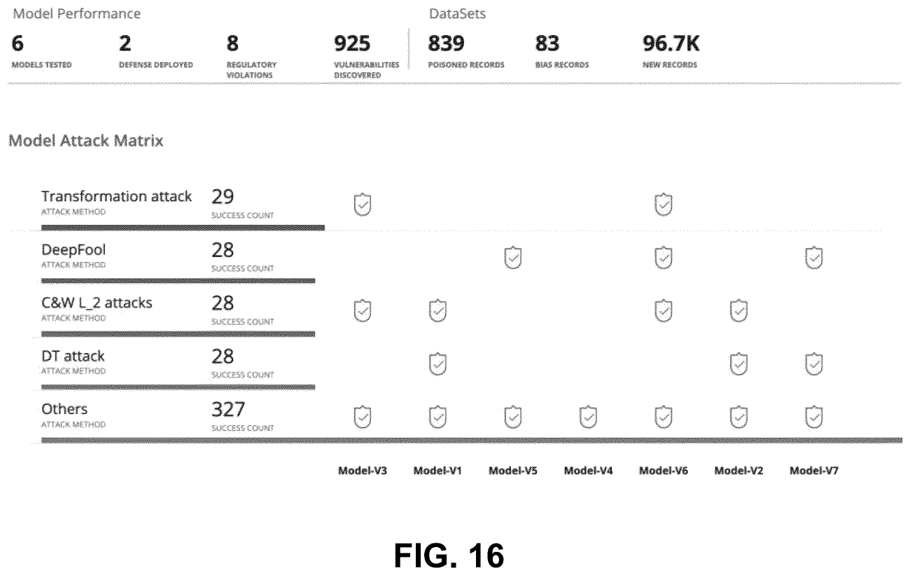

Similarly, FIG. 16 showcases a monitoring dashboard of a user interface application, which may be the same or a different user-interface application as in FIGS. 12-13. The monitoring dashboard may be configured to display, on the user device display, the results of various adversarial attacks in the assessment process of FIG. 11. In some embodiments, the results are displayed in real-time, being updated with a predefined frequency. The reporting component 230 may be configured to generate the content for the monitoring dashboard in FIG. 16.

The computer-implemented method of FIG. 11, exemplified by the Case Study but not limited to that specific embodiment, finds numerous advantageous applications in industrial settings.

In a first example, the method of FIG. 11, and the system of FIG. 2, can be used in the field of credit card fraud detection where ML models are being used by banks to identify fraud. The threat modelling component 210 may develop 1110-1120 a threat taxonomy to identify potential attacks on the bank's models, such as fraudsters submitting fake transactions, and map system vulnerabilities (blind spots) and threat models. The assessment component 220 may then perform 1130 one or more adversarial attacks on the ML model. The adversarial attack(s) may include but are not limited to testing with synthetic fraud patterns and trying to bypass detection with subtle transaction modifications. The assessment component 220 may then identify 1140 any failure mode(s) in the model based on the result of attack(s) it performed. For example, this may involve identifying transaction patterns that fooled the model and identifying blind spots in fraud detection. Subsequently, the reporting component 230 may report the findings to stakeholders, such as bank managers. The report generated by the reporting component 230 may comprise numerous different elements, such as but not limited to an indication of model vulnerabilities, and a recommendation of specific security improvements that could be made to address those vulnerabilities.

Referring back to the ML lifecycle stages illustrated in FIG. 1, the data management stage 110 may comprise but is not limited to the following characteristics in the credit card fraud example:
i. Extractors: Real-time transaction data ingestion systems
ii. Transformers: Transaction normalization and feature computation
iii. Filters: Anomaly and outlier detection pre-processing
iv. Validators: Transaction data quality checks
v. Labelers: Fraud case marking and verification
vi. Feature Stores: Distributed storage for transaction features

The model training and development stage 120 may comprise but is not limited to the following characteristics in the credit card fraud example:
i. Model Repository: Version control for fraud detection models
ii. Compilers: Model optimization for real-time inference
iii. Validators: Performance metrics on fraud detection
iv. Evaluators: False positive/negative analysis
v. Explanations: Transaction decision justification
vi. Exp. Trackers: Model experiment versioning

The model inference stage 130 may comprise but is not limited to the following characteristics in the credit card fraud example:
i. Feature Server Real-time feature computation
ii. Batch/Online Predictors: Transaction scoring systems
iii. Performance Monitoring: Fraud detection accuracy tracking

Lastly, the deployment and integration stage 140 may comprise but is not limited to the following characteristics in the credit card fraud example:
i. Inference/XAIs: Real-time fraud detection endpoints
ii. App Framework: Integration with banking systems
iii. Clients: Fraud analyst dashboards and tools

In example of credit card fraud, the threat taxonomy 300 developed by the threat modelling component 210 may include, but are not limited to, data pipeline threats and/or model threats. The data pipeline threats may comprise one or more of data poisoning during transaction ingestion, manipulation of training datasets, unauthorized access to feature stores, and compromising of data labeling systems, but not limited to these examples. The model threats may comprise one or more of model extraction attacks, backdoor injection attempts, training pipeline compromises, and model theft attempts, but not limited to these examples.

The adversarial attacks performed by the assessment component 220 on the ML model in the credit card fraud example may include, but are not limited to, transaction manipulation and/or system probing. Transaction manipulation attacks may comprise one or more of gradual drift in transaction patterns, slit transaction attacks, time-based attack patterns, and geographic location spoofing, but not limited to these examples. System probing attacks may comprise one or more of model boundary testing, confidence score manipulation, feature importance probing, and rate limiting bypass attempts, but not limited to these examples.

The failure modes of an ML model in the credit card fraud example, which the assessment component 220 is configured to identify based on the results of the adversarial attacks it performs, may include but are not limited to detection blind spots and/or system failures. Detection blind spots may comprise one or more of new fraud patterns, edge case transactions, high-value legitimate transactions, and cross-border transactions, but not limited to these examples. System failures may comprise one or more of high latency scenarios, feature computation errors, model serving failures, and integration timeouts, but not limited to these examples.

Features of the report generated by the reporting component 230 may be divided into sub-categories including but not limited to reports for technical teams such as ML engineers, and reports for business stakeholders (i.e., non-technical personnel). The reports for the technical teams may comprise one or more of vulnerability assessment reports, performance degradation analysis, system reliability metrics, and security patch requirements, but not limited to these examples. The reports for business stakeholders may comprise one or more of risk exposure metrics, financial impact analysis, compliance status reports, and improvement recommendations, but not limited to these examples.

In another example, the method of FIG. 11, and the system of FIG. 2, can be used in the field of medical image classification ML models. The threat modelling component 210 may develop 1110-1120 a threat taxonomy to identify potential attacks on the image classification models, such as but not limited to tampering with medical images and identify critical access points. The assessment component 220 may then perform 1130 one or more adversarial attacks on the ML model. The adversarial attack(s) may include but are not limited to testing the model with altered images of various kinds and trying to “fool” or “trick” the diagnosis systems of the model. The assessment component 220 may then identify 1140 any failure mode(s) in the model based on the result of attack(s) it performed. For example, the assessment component 220 may identify which adversarial attacks, e.g. which image alterations, resulted in a misdiagnosis of a condition by the model. Subsequently, the reporting component 230 may report the findings to stakeholders, such as medical professionals. The report generated by the reporting component 230 may comprise numerous different elements, such as but not limited to an indication of model vulnerabilities, and a recommendation of specific security improvements that could be made to address those vulnerabilities.

Referring back to the ML lifecycle stages illustrated in FIG. 1, the data management stage 110 may comprise but is not limited to the following characteristics in the medical imaging classification example:
i. Extractors: DICOM image acquisition systems
ii. Transformers: Image preprocessing and standardization
iii. Filters: Image quality control and artifact removal
iv. Validators: Image metadata verification
v. Labelers: Medical expert annotation systems
vi. Feature Stores: Secure medical image repositories

The model training and development stage 120 may comprise but is not limited to the following characteristics in the medical imaging classification example:
i. Model Repository: Medical imaging model versions
ii. Compilers: GPU optimization for image processing
iii. Validators: Clinical accuracy verification
iv. Evaluators: Diagnostic performance assessment
v. Explanations: Diagnosis reasoning system
vi. Exp. Trackers: Clinical validation tracking

The model inference stage 130 may comprise but is not limited to the following characteristics in the medical imaging classification example:
i. Feature Server Image feature extraction
ii. Batch/Online Predictors: Diagnostic classification
iii. Performance Monitoring: Clinical accuracy metrics

Lastly, the deployment and integration stage 140 may comprise but is not limited to the following characteristics in the medical imaging classification example:
i. Inference/Explainable APIs: Picture archiving and communication system (PACS) integration endpoints
ii. App Framework: Hospital system integration
iii. Clients: Radiologist workstations and viewers

In example of medical imaging classification, the threat taxonomy 300 developed by the threat modelling component 210 may include, but are not limited to, data pipeline threats and/or model threats. The data pipeline threats may comprise one or more of image tampering during transfer, training data poisoning, protected health information (PHI) exposure risks, and annotation system compromise, but not limited to these examples. The model threats may comprise one or more of adversarial image modifications, m del inversion attacks, training data reconstruction, and unauthorized model access, but not limited to these examples.

The adversarial attacks performed by the assessment component 220 on the ML model in the medical imaging classification example may include, but are not limited to, image manipulation and/or system probing. Image manipulation attacks may comprise one or more of subtle artifact injection, contrast/brightness manipulation, resolution modifications, and metadata tampering, but not limited to these examples. System probing attacks may comprise one or more of confidence score manipulation, decision boundary testing, feature sensitivity analysis and access control probing, but not limited to these examples.

The failure modes of an ML model in the medical imaging classification example, which the assessment component 220 is configured to identify based on the results of the adversarial attacks it performs, may include but are not limited to clinical blind spots and/or system failures. Detection blind spots may comprise one or more of rare pathology cases, image quality variations, demographic biases, and novel medical conditions, but not limited to these examples. System failures may comprise one or more of processing pipeline errors, integration failures, resource exhaustion, and communication breakdowns, but not limited to these examples.

Features of the report generated by the reporting component 230 may be divided into sub-categories including but not limited to reports for medical professionals, and reports for business stakeholders (e.g., non-medical personnel). The reports for the medical professionals may comprise one or more of clinical accuracy reports, system limitation documentation, safety protocol updates, and training requirements, but not limited to these examples. The reports for business stakeholders may comprise one or more of risk assessment reports, compliance status updates, resource utilization metrics, and improvement recommendations, but not limited to these examples.

In embodiments of the present disclosure, the method of FIG. 11 may further include performing 1710 remediation step(s) on one or more features or inputs of the ML model based on the identified failure mode(s) of the model. As present in FIG. 17, the performance of remediation steps may be in addition, or alternatively to, the step 1150 of generating a report based on results of the assessment in prior steps 1110-1140. It will be understood that remediation steps may include any appropriate steps that at least partially, preferably entirely, address the security weaknesses identified in relation to the model. For example, if the failure mode relates to data poisoning, the remediation may include sanitizing the model's input data. Remediation steps are preferably carried out by the risk mitigation component 200 but may be carried out by another software application not forming part of the system.

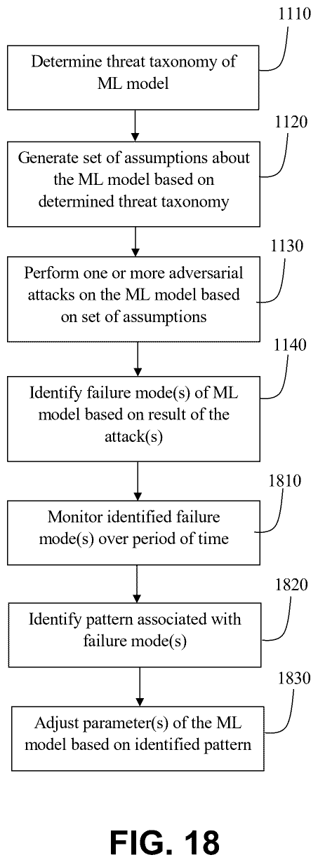

In embodiments of the present disclosure presented in FIG. 18, the method of FIG. 11 may further comprise monitoring 1810 failure mode(s) over a period of time, identifying 1820 a pattern or trend associated with one or more failure modes, and adjusting 1830 one or more parameters of the ML model based on the identified pattern or trend. The model parameters for adjustment may include but are not limited to weight(s) connected one or more nodes of a neural network, a learning rate, a decay rate, a batch size, a number of epochs, regularization parameters, a dropout rate, a number of layers of a neural network, an activation function, a loss function, a kernel size, a kernel stride, a tree depth, and so on. The model parameters are preferably adjusted by the risk mitigation component 200, although this function may be performed by another software application dependent on the setting.

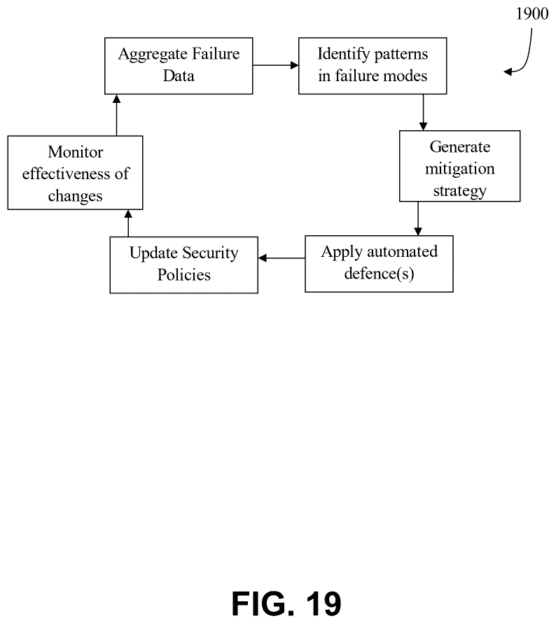

Referring now to FIG. 19, the method of FIG. 11 may utilize a security loop comprised of several steps. In a first step, failure data corresponding to failure mode(s) of the ML model is aggregated. The aggregation may optionally be performed by the assessment component 220 or the risk mitigation component 200. Patterns associated with the failure modes are identified, and a mitigation strategy is generated. The identification of patterns is preferably performed by the assessment component 220, whilst the risk mitigation component 200 generates the mitigation strategy. As part of the mitigation strategy, or in the interim while it is deployed, automated defenses of the ML model and/or its associated entities may be applied to reduce any risk of the model being further compromised. The security policies of the ML model and/or its associated entities may be updated based on the determined failure mode patterns. The effectiveness of these changes, e.g. of the mitigation strategy, may be assessed on an ongoing basis by the assessment component 220. Repeating these steps of the security loop 1900 may further enhance the robustness of the protocol in FIGS. 11, 17, and 18.

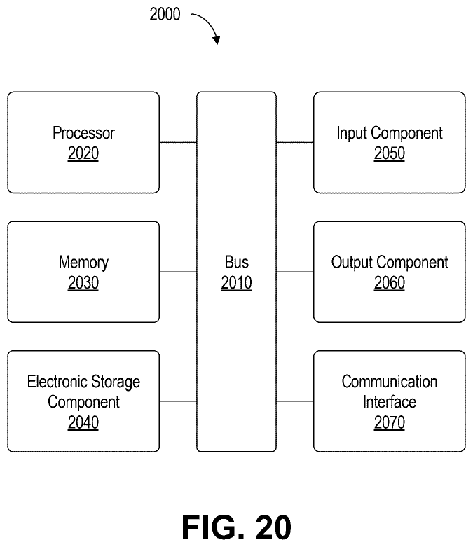

FIG. 20 is a diagram of example components of a device 2000, according to one or more implementations herein. The device 2000 may correspond to one or more device, network, resource, or service of FIGS. 1-19. In some implementations, one or more device, network, resource, or service of FIGS. 1-19 may include one or more of the devices 2000 and/or one or more components of the device 2000, for example, according to a client/server architecture, a peer-to-peer architecture, and/or other architectures, which may include a plurality of hardware, software, and/or firmware components operating together to provide the functionality attributed herein to the device 2000. In some implementations, the device 2000 may include a distributed computing architecture (e.g., one or more individual computing platforms operating in concert to accomplish a computing task). For example, the device 2000 may be implemented by a cloud of computing platforms operating together as the device 2000. By way of non-limiting example, a given device 2000 may include one or more of a server, a desktop computer, a laptop computer, a handheld computer, a tablet computing platform, a Netbook, a Smartphone, a gaming console, and/or other computing platforms.

As used herein, the term “component” is intended to be broadly construed as hardware, firmware, software, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

The device 2000 may include a bus 2010, a processor 2020, a memory 2030, a storage component 2040, an input component 2050, an output component 2060, and a communication component 2070.

The bus 2010 includes a component that enables wired and/or wireless communication among the components of device 2000. The bus 2010 may enable various components of a computer system to communicate with each other, allowing for the transfer of data from one part to another.

The processor 2020 may include a central processing unit, a graphics processing unit, a microprocessor, a controller, a microcontroller, a digital signal processor, a field-programmable gate array (FPGA), an application-specific integrated circuit, and/or another type of processing component. The processor 2020 may be implemented in hardware, firmware, or a combination of hardware and software. In some implementations, the processor 2020 may include one or more processors capable of being programmed to perform a function. Such processors may or may not be all integral to the same physical device and may in some embodiments be distributed among several devices.

The processor 2020 may be configured to execute one or more of the modules disclosed herein, and/or other modules by software; hardware; firmware; some combination of software, hardware, and/or firmware; and/or other mechanisms for configuring processing capabilities on the processor 2020. As used herein, the term “module” may refer to any component or set of components that perform the functionality attributed to the module. This may include one or more physical processors during execution of processor readable instructions, the processor readable instructions, circuitry, hardware, storage media, or any other components. Various modules or portions thereof may be implemented in any of various ways, including procedure-based techniques, component-based techniques, and/or object-oriented techniques, among others. For example, the program instructions may be implemented using system libraries, language libraries, model-view-controller (MVC) principles, application programming interfaces (APIs), large language models (LLMs), system-specific programming languages and principles, cross-platform programming languages and principles, pre-compiled programming languages, markup programming languages, stylesheet languages, “bytecode” programming languages, object-oriented programming principles or languages, other programming principles or languages, C, C++, C#, Java, JavaScript, Python, PHP, HTML, CSS, TypeScript, R, Elm, Unity, VB.Net, Visual Basic, Swift, Objective-C, Perl, Ruby, Go, SQL, Haskell, Scala, Arduino, assembly language, Microsoft Foundation Classes (MFC), Streaming SIMD Extension (SSE), or other technologies or methodologies, as desired.

It should be appreciated that although some modules disclosed herein may be illustrated for example as being implemented within a single processing unit, in embodiments in which the processor 2020 includes multiple processing units, one or more of modules disclosed herein may be implemented remotely from the other modules. The description of the functionality provided by the different modules disclosed herein is for illustrative purposes, and is not intended to be limiting, as any of modules described herein may provide more or less functionality than is described. For example, one or more of modules disclosed herein may be eliminated, and some or all of its functionality may be provided by other ones of modules disclosed herein. As another example, the processor 2020 may be configured to execute one or more additional modules that may perform some or all of the functionality attributed herein to one of modules disclosed herein.

The memory 2030 may include a random-access memory, a read only memory, and/or another type of memory (e.g., a flash memory, a magnetic memory, and/or an optical memory).

The electronic storage component 2040 may store information and/or software related to the operation of the device 2000. For example, the electronic storage component 2040 may include a solid-state disk drive, a hard disk drive, a magnetic disk drive, an optical disk drive, a compact disc, a digital versatile disc, and/or another type of non-transitory computer-readable medium. Implementations of the electronic storage component 2040 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Implementations of the electronic storage component 2040 may include one or both of system storage provided integrally (i.e., substantially non-removable) to the device 2000 and/or removable storage that is removably connectable to the device 2000 via, for example, a port (e.g., a serial port, a USB port, an IEEE 1394 port, a THUNDERBOLT™ port, etc.) or a drive (e.g., disk drive, flash drive, or solid-state drive etc.). The electronic storage component 2040 may also or alternatively include one or more virtual storage resources (e.g., cloud storage, a virtual private network, and/or other virtual storage resources). An electronic storage may store software algorithms, information determined by one or more processors, information received from one or more computing platforms, information received from one or more remote platforms, databases (e.g., structured query language (SQL) databases (e.g., MYSQL®, MARIADB®, MONGODB®), NO-SQL databases, among others), data files, compiled data, analyzed data, charts, tables, videos, images, presentations, and 3D content in the respective format and/or other information enabling a computing platform to function as described herein.

The input component 2050 may enable the device 2000 to receive input, such as user input and/or sensed inputs. For example, the input component 2050 may include a touch screen, a keyboard, a keypad, a mouse, a button, a microphone, a switch, a sensor (internal and/or external), a global positioning system component, an accelerometer, a gyroscope, and/or an actuator.

The output component 2060 may enable the device 2000 to provide output, such as via a display, a speaker, and/or one or more light-emitting diodes.

The communication component 2070 may enable the device 2000 to communicate with other devices, such as via a wired connection and/or a wireless connection, for example, via the internet and/or other networks using, for example, TCP/IP or cellular hardware enabling wired or wireless (e.g., cellular, 2G, 3G, 4G, 4G LTE, 5G, wireless local area network, near field communication (NFC), BLUETOOTH®) communication. For example, the communication component 2070 may include a receiver, a transmitter, a transceiver, a modem, a network interface card, and/or an antenna.

Implementations may implement or interact with machine learning, a type of artificial intelligence (AI) that provides computers with an ability to learn how to process data without being explicitly programmed. Machine learning focuses on the development of computer programs that can teach themselves to grow and change when exposed to new data. Machine learning explores the study and construction of algorithms that can learn from and make predictions based on data. Such algorithms may overcome following strictly static program instructions by making data-driven predictions or decisions, through building a model from sample inputs.

Machine learning may refer to a variety of AI software algorithms, which may be used to perform supervised learning, unsupervised learning, reinforcement learning, deep learning, or any combination thereof. A variety of different machine learning algorithms may be employed in implementations. Examples of machine learning algorithms may include, inter alia, artificial neural network algorithms, Gaussian process regression algorithms, fuzzy logic-based algorithms, or decision tree algorithms.

In some implementations, more than one machine learning algorithm may be employed. For example, automated classification may be implemented using one type of machine learning algorithm, and adaptive real-time process control may be implemented using a different type of machine learning algorithm. In some implementations, hybrid machine learning algorithms including features and properties drawn from two, three, four, five, or more different types of machine learning algorithms may be employed in implementations.

Supervised learning algorithms may use labeled training data to infer a relationship between one or more identifiable aspects of a given entity and a classification of the entity according to a specified set of criteria or to infer a relationship between input process control parameters and desired outcomes. The training data may include paired training examples. For example, each training data example may include aspects identified for a given entity and the resultant classification of the given entity. As a further example, each training data example may include process control parameters used in a process and a known outcome of the process.

Unsupervised learning algorithms may be used to draw inferences from training data including entity data not paired with labeled entity classification data, or input process control parameter data not paired with labeled process outcomes. An example unsupervised learning algorithm is cluster analysis, which may be used for exploratory data analysis to find hidden patterns or groupings in process data.

Semi-supervised learning algorithms may use both labeled and unlabeled object classification or process data for training. Semi-supervised learning algorithms may typically use a small amount of labeled data with a large amount of unlabeled data.

Reinforcement learning algorithms may be used, for example, to optimize a process (e.g., steps or actions of the process) to maximize a process reward function or minimize a process loss function. In machine learning environments, reinforcement learning algorithms may be formulated as Markov decision processes. Reward functions or loss functions, which may also be referred to as cost functions or error functions, may map values of one or more process variables and/or outcomes to a real number that represents a reward or cost, respectively, associated with a given process outcome or event. Examples of process parameters and process outcomes include, inter alia, process throughput, process yield, production quality, or production cost. In some cases, the definition of the reward or loss function to be maximized or minimized, respectively, may depend on the choice of machine learning algorithm used to run the process control method, or vice versa. For example, if an objective is to maximize a total reward/value function, a reinforcement learning algorithm may be chosen. If the objective is to minimize a mean squared error loss function, a decision tree regression algorithm or linear regression algorithm may be chosen. In general, the machine learning algorithm used to run the process control method will seek to optimize the reward function or minimize the loss function by identifying the current state of the process; comparing the current state to the reference state, which may be a target intermediate or final state; and adjusting one or more process control parameters to minimize a difference between the two states. This adjustment may include reference to past learning provided by a training data set. Reinforcement learning algorithms differ from supervised learning algorithms in that correct training data input/output pairs are not presented, nor are sub-optimal actions explicitly corrected. Implementations of these algorithms tend to focus on real-time performance by finding a balance between exploration of possible outcomes based on updated input data and exploitation of past training.

Deep learning, which may also be known as deep structured learning, hierarchical learning, or deep machine learning, may be based on a set of algorithms that attempt to model high level abstractions in data. Deep learning algorithms may be inspired by the structure and function of the human brain and are part of a broader family of machine learning methods based on learning representations of data. Rooted in neural network technology, deep learning may involve a probabilistic graph model having many neuron layers, commonly known as a deep architecture. Deep learning technology may process information such as, inter alia, image, text, or sound information in a hierarchical manner. An observation (e.g., a feature to be extracted for reference) can be represented in many ways including, for example, a vector of intensity values, a set of edges, regions of shape, or in another abstract manner. Some representations may simplify the learning task (e.g., face recognition or facial expression recognition). Deep learning can provide efficient algorithms for unsupervised or semi-supervised feature learning and hierarchical feature extraction. implementations employing deep learning can further benefit from the advantage of deep learning concepts in solving a normally intractable representation inversion problem.

A deep learning module may be configured as a neural network. The deep learning module may further be a deep neural network with a set of weights that model the world based on training using training data. Neural networks can be understood to implement a computational approach-based on a relatively large collection of neural units—to loosely model the way a human brain solves problems with large clusters of biological neurons connected by axons. Each neural unit may be connected to one or more others, and links can be enforcing or inhibitory in their effect on the activation state of connected neural units. These systems may be self-learning and trained rather than explicitly programmed. Neural network systems excel in areas where a solution or feature detection is difficult to express in a traditional computer program.

An example of a deep learning algorithm may be an artificial neural network (ANN). Large ANNs including many layers may be used, for example, to map entity data to entity classification decisions or to map input process control parameters to desired process outcomes. ANNs will be discussed in further detail below.

Neural networks typically include multiple layers, and the signal path may traverse from front to back. The goal of neural networks may be to solve problems in a similar manner to the human brain, although several neural networks may be much more abstract. In a simple example of a neural network, there may be two layers (i.e., sets) of neurons: an input layer that receives an input signal and an output layer that sends an output signal. When the input layer receives an input, it may pass a modified version of the input to the next layer. In a deep network, there may be many layers between the input layer and output layer, allowing the algorithm to use multiple processing layers, which may include multiple linear and non-linear transformations. Modern neural networks typically work with a few thousand to a few million neural units and millions of connections. Neural networks may have various suitable architectures and/or configurations known in the art.

There are many variants of neural networks with deep architecture depending on the probability specification and network architecture, including, inter alia, deep belief networks (DBN), restricted Boltzmann machines (RBM), random forests, and autoencoders. Implementations of neural networks may vary depending on the size of input data, the number of features to be analyzed, and the nature of the problem. Other layers may be included in the deep learning module besides the neural networks disclosed herein.

Another type of deep neural network may be a convolutional neural network (CNN), which can be used for analysis of an entity or process. CNNs are commonly composed of layers of different types: convolution, pooling, upscaling, and fully connected layers. In some cases, an activation function such as a rectified linear unit (ReLU) function may be used in some of the layers. In a CNN architecture, there can be one or more layers for each type of operation performed. A CNN architecture may include any number of layers in total, and any number of layers for the different types of operations performed. The simplest CNN architecture starts with an input layer followed by a sequence of convolutional layers and pooling layers (e.g., layers otherwise configured for reducing the dimensionality of the feature map generated by the one or more convolutional layers while retaining the most important features, for example, max pooling layers) and ends with fully connected layers (e.g., a layer in which each of the nodes is connected to each of the nodes in the previous layer). Each convolution layer may include a plurality of parameters used for performing the convolution operations. Each convolution layer may also include one or more filters, which in turn may include one or more weighting factors or other adjustable parameters. In some instances, the parameters may include biases (e.g., parameters that permit an activation function to be shifted). In some cases, the convolutional layers may be followed by an ReLU activation function layer. Other activation functions can also be used, for example, inter alia, saturating hyperbolic tangent, identity, binary step, logistic, arctan, softsign, parametric rectified linear unit, exponential linear unit, softPlus, bent identity, softExponential, Sinusoid, Sinc, Gaussian, or sigmoid functions. The convolutional, pooling and ReLU layers may function as learnable feature extractors, while the fully connected layers may function as machine learning classifiers. As with other artificial neural networks, the convolutional layers and fully connected layers of CNN architectures may include various computational parameters, for example, weights, bias values, and threshold values, which may be trained in a training phase.

Another type of deep neural network may be a visual geometry group (VGG) network. For example, VGG networks may be created by increasing the number of convolutional layers while fixing other parameters of the architecture. Adding convolutional layers to increase depth may be made possible by using substantially small convolutional filters in all of the layers. VGG networks may also include convolutional layers followed by fully connected layers.

Another type of deep neural network may be a deep residual network. Like some other networks described herein, a deep residual network may include convolutional layers followed by fully connected layers, which may be, in combination, configured and trained for feature property extraction. A deep residual network's layers may be configured to learn residual functions with reference to layer inputs, instead of learning unreferenced functions. Instead of relying on a direct fit of few stacked layers to a desired underlying mapping, a deep residual network's layers may be explicitly allowed to fit a residual mapping, which may be realized by feedforward neural networks having shortcut connections (i.e., connections that skip one or more layers). A deep residual network may be created by inserting shortcut connections into a plain neural network structure including convolutional layers, thereby modifying the plain neural network into a residual learning network.

In some implementations, the machine learning module may include a support vector machine (SVM), an artificial neural network (ANN), a decision tree-based expert learning system, an autoencoder, a clustering machine learning algorithm, or a nearest neighbor (e.g., kNN) machine learning algorithm, or combinations thereof, some of which will be described in further detail below.

Support vector machines (SVMs) may be supervised learning algorithms used for classification and regression analysis of entity classification data or process control. Given a set of training data examples (e.g., entity or process data), each marked as belonging to a category, an SVM training algorithm may build a model that assigns new examples (e.g., data from a new entity or process) to a given category.

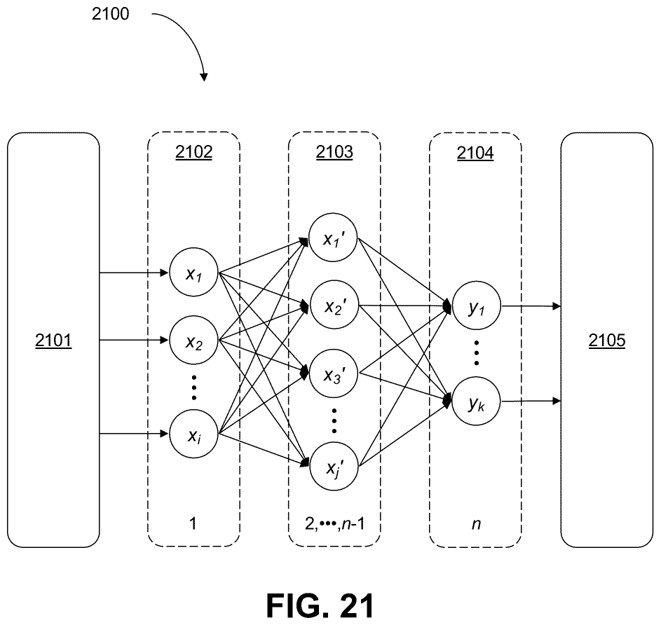

FIG. 21 illustrates an artificial neural network (ANN) 2100, according to an implementation. ANN 2100 may be used for, inter alia, classification or process control optimization according to various implementations.

ANN 2100 may include any type of neural network module, such as, inter alia, a feedforward neural network, radial basis function network, recurrent neural network, or convolutional neural network.

In implementations implementing ANN 2100 for entity classification, ANN 2100 may be employed to map entity data to entity classification data. In implementations implementing ANN 2100 for process optimization, ANN 2100 may be employed to determine an optimal set or sequence of process control parameter settings for adaptive control of a process in real-time based on a stream of process monitoring data and/or entity classification data provided by, for example, observation or from one or more sensors. ANN 2100 may include an untrained ANN, a trained ANN, pre-trained ANN, a continuously updated ANN (e.g., an ANN utilizing training data that is continuously updated with real time classification data or process control and monitoring data from a single local system, from a plurality of local systems, or from a plurality of geographically distributed systems).

ANN 2100 may include interconnected nodes (e.g., x₁-xᵢ, x₁′-xⱼ′, and y₁-yₖ) organized into n layers of nodes, where x₁-xᵢ represents a group of inodes in an input layer 2102 (e.g., layer 1), x₁′-xⱼ′represents a group of j nodes in one or more hidden layers 2103 (e.g., layer(s) 2 through n−1), and y₁-yₖ represents a group of k nodes in a final layer 2104 (e.g., layer n). Input layer 2102 may be configured to receive input data 2101 (e.g., sensor data, image data, sound data, observed data, automatically retrieved data, manually input data, etc.). Final layer 2104 may be configured to provide result data 2105.

There may be one or more hidden layers 2103, and the number j of nodes in the one or more hidden layers 2103 may vary from implementation to implementation. Thus, ANN 2100 may include any total number of layers (e.g., the one or more hidden layers 2103). One or more of the hidden layers 2103 may function as trainable feature extractors, which may allow mapping of input data 2101 to preferred result data 2105.

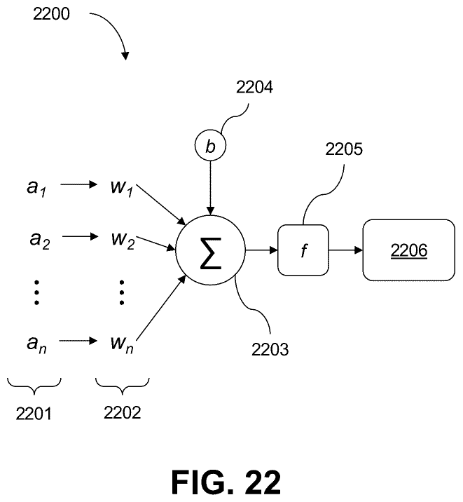

FIG. 22 illustrates a node 2200, according to an implementation. Each layer of a neural network may include one or more nodes similar to node 2200, for example, nodes x₁-xᵢ, x₁′-xⱼ′, and y₁-yₖ depicted in FIG. 21. Each node may be analogous to a biological neuron.

Node 2200 may receive node inputs 2201 (e.g., a₁-aₙ) either directly from the ANN's input data (e.g., input data 2101) or from the output of one or more nodes in a different layer or the same layer. With node inputs 2201, the node 2200 may perform an operation 2203, which while depicted in FIG. 22 as a summation operation, would be readily understood to include various other operations known in the art.

In some cases, node inputs 2201 may be associated with one or more weights 2202 (e.g., w₁-wₙ), which may represent weighting factors. For example, operation 2203 may sum the products of each of node inputs 2201 and associated weights 2202 (e.g., aᵢwᵢ).

The result of operation 2203 may be offset with one or more biases 2204 (e.g., bias b), which may be a value or a function.

Output 2206 of node 2200 may be gated using an activation (or threshold) function 2205 (e.g., function ƒ), which may be a linear or a nonlinear function. Activation function 2205 may be, for example, a ReLU activation function or other function such as a saturating hyperbolic tangent, identity, binary step, logistic, arctan, softsign, parametric rectified linear unit, exponential linear unit, softPlus, bent identity, softExponential, Sinusoid, Sinc, Gaussian, or sigmoid function, or any combination thereof.

Weights 2202, biases 2204, or threshold values of activation function 2205, or other computational parameters of the neural network, can be “taught” or “learned” in a training phase using one or more sets of training data. For example, the parameters may be trained using input data from a training data set and a gradient descent or backward propagation method so that the output value(s) (e.g., a set of predicted adjustments to classification or process control parameter settings) computed by the ANN may be consistent with the examples included in the training data set. The parameters may be obtained, for example, from a back propagation neural network training process, which may or may not be performed using the same hardware as that used for automated classification or adaptive, real-time deposition process control.

Decision tree-based expert systems may be supervised learning algorithms designed to solve entity classification problems or process control problems by applying a series of conditional (e.g., if-then) rules. Expert systems may include two subsystems: an inference engine and a knowledge base. The knowledge base may include a set of facts (e.g., a training data set including entity data for a series of entities, and the associated entity classification data provided by, for example, a skilled operator, technician, or inspector) and derived rules (e.g., derived entity classification rules). The inference engine may then apply the rules to input data for a current entity classification problem or process control problem to determine a classification of the entity or a next set of process control adjustments.

Autoencoders (also sometimes referred to as an auto-associator or Diabolo network), may be an ANN used for unsupervised and efficient mapping of input data (e.g., entity data or process data), to an output value (e.g., an entity classification or optimized process control parameters). Autoencoders may be used for the purpose of dimensionality reduction, that is, a process of reducing the number of random variables under consideration by deducing a set of principal component variables. Dimensionality reduction may be performed, for example, for the purpose of feature selection (e.g., selecting a subset of the original variables) or feature extraction (e.g., transforming of data in a high-dimensional space to a space of fewer dimensions).

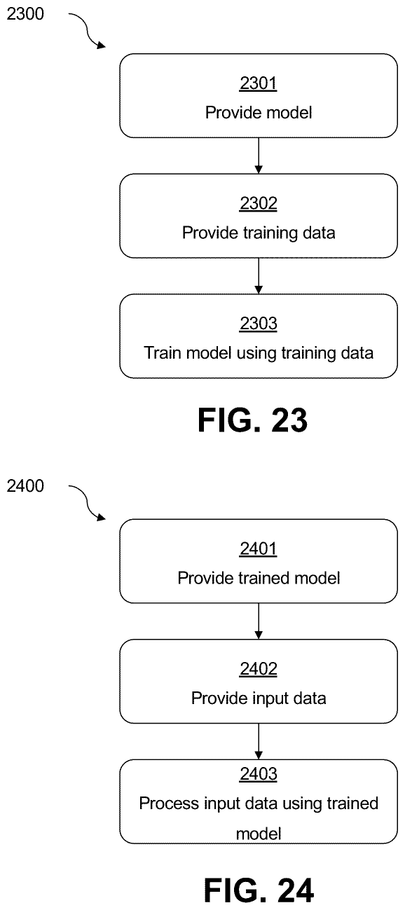

FIG. 23 illustrates a method 2300 of training a machine learning model of a machine learning module, according to an implementation. Use of method 2300 may provide for use of training data to train a machine learning model for concurrent or later use.

At 2301, a machine learning model including one or more machine learning algorithms may be provided.

At 2302, training data may be provided. Training data may include one or more of process simulation data, process characterization data, in-process or post-process inspection data (including inspection data provided by a skilled operator and/or inspection data provided by any of a variety of automated inspection tools), or any combination thereof, for past processes that are the same as or different from that of the current process. One or more sets of training data may be used to train the machine learning algorithm used for object defect detection and classification. In some cases, the type of data included in the training data set may vary depending on the specific type of machine learning algorithm employed.

At 2303, the machine learning model may be trained using the training data. For example, training the model may include inputting the training data to the machine learning model and modifying one or more parameters of the model until the output of the model is the same as (or substantially the same as) external validation data. Model training may generate one or more trained models. One or more trained models may be selected for further validation or deployment, which may be performed using validation data. The results produced by each trained model for the validation data input to the training model may be compared to the validation data to determine which of the models is the best model. For example, the trained model that produces results most closely matching the validation data may be selected as the best model. Test data may then be used to evaluate the selected model. The selected model may also be sent to model deployment in which the best model may be sent to the processor for use in a post-training mode.

FIG. 24 illustrates a method 2400 of analyzing input data using a machine learning module, according to an implementation. Use of the machine learning module described by method 2400 may enable, for example, automatic classification of an entity or optimized process control.

At 2401, a trained machine learning model may be provided to the machine learning module. The trained machine learning model may have been trained, or under continuous or periodic training by one or more other systems or methods. The machine learning model may be pre-generated and trained, enabling functionality of the module as described herein, which can then be used to perform one or more post-training functions of the machine learning module.

For example, the provided trained machine learning model may be similar to ANN 2100, include nodes similar to node 2200, and may have been trained (or be under continuous or periodic training) using a method similar to method 2300.

At 2402, input data may be provided to the machine learning module for input into the machine learning model. The input data may result from or be derived from a variety of different sources, similar to input data 2101.

The provision of input data at 2402 may further include removing noise from the data prior to providing it to the machine learning algorithm. Examples of data processing algorithms suitable for use in removing noise from the input data may include, inter alia, signal averaging algorithms, smoothing filter algorithms, Kalman filter algorithms, nonlinear filter algorithms, total variation minimization algorithms, or any combination thereof.

The provision of input data at 2402 may further include subtraction of a reference data set from the input data to increase contrast between aspects of interest of an entity or process and those not of interest, thereby facilitating classification or process control optimization. For example, a reference data set may include input data for a real or contrived ideal example of the entity or process. If an image sensor or machine vision system is used for entity observation, the reference data set may include an image or set of images (e.g., representing different views) of an ideal entity.

At 2403, the machine learning module may process the input data using the trained machine learning model to yield results from the machine learning module. Such results may include, for example, an entity classification or one or more optimized process control parameters.

The invention is limited only by the appended claims. Variations, characteristics, advantages, implementations, constructions, arrangements, terminology, materials, dimensions, embodiments, illustrations, depictions, and examples composing the above description and accompanying drawings show some possible implementations of the invention without limiting the invention. It is not necessary that every implementation of the invention achieve or possess every advantage, purpose, or characteristic identified herein, and as such, one skilled in the art may effect various additions, changes, modifications, or omissions without departing from the scope or spirit of the invention or its legal equivalents.

All ranges are inclusive of the stated limits, the orders of magnitude thereof, and all values and ranges substantially therebetween unless otherwise defined. Unless otherwise stated, every use of “and” forms an inclusive list comprising at least the conjoined elements, and every use of “or” forms an inclusive list comprising at least one element of conjoined elements. Unless otherwise stated, singular usage (e.g., ‘a’, ‘an’, or ‘the’) includes plurals of the same.

The order of recitations in a claim do not imply a temporal or ordered relationship unless unavoidable by the plain language of that claim. No claim may be interpreted to invoke 35 U.S.C. § 112(f) unless that claim recites “means for” or “step for.”

We claim:

1. A method for performing security evaluation on a machine learning model, comprising, using a processor:
determining a taxonomy of the machine learning model and of an environment in which the machine learning model is implemented at one or more stages in a lifecycle of the machine learning model;
generating, based on the determined taxonomy, a set of assumptions about the machine learning model and the environment;
performing a first adversarial test attack on the machine learning model at a stage in the machine learning model's lifecycle, based at least in part on the set of assumptions; and
identifying one or more failure modes in the machine learning model based on a result of the first adversarial attack.

2. The method of claim 1, further comprising assessing an effect of the one or more failure modes on a subsequent stage in the machine learning model's lifecycle.

3. The method of claim 1, wherein determining the taxonomy comprises identifying one or more of: one or more assets associated with the machine learning model, one or more adversaries, one or more adversary goals, an attack specificity, an error specificity, an attack vector, an attack method, an attack phase, an adversary strategy, one or more resources available to the adversary, a level of access an adversary possesses, a level of knowledge the adversary possesses, a vulnerability of an asset associated with the machine learning model, and a defence mechanism of the machine learning model.

4. The method of claim 3, wherein the taxonomy comprises identifying a level of access the adversary possesses, and wherein the level of access is evaluated based on one or more of: a model or explanation access, a raw data access, a data collector access, a feature extraction and transformations function access, a model training data access, access to a similar model architecture, and a query-based access.

5. The method of claim 3, wherein the taxonomy comprises identifying a level of knowledge the adversary possesses, and wherein the level of knowledge is evaluated based on one or more of: a task knowledge, a platform knowledge, and knowledge of the machine learning model or training data used to build or train the model.

6. The method of claim 1, wherein generating the set of assumptions comprises mapping adversarial attack stages to one or more of: asset(s) associated with the machine learning model, a vulnerability of an asset associated with the machine learning model, an attack being in an inference or a training phase of the machine learning model, a level of access an adversary possesses, and a level of knowledge the adversary possesses.

7. The method of claim 1, wherein the determining the taxonomy is performed by a threat modelling component that is trained on one or more of: data/deployment flow diagrams, machine learning models, data stores, stakeholders' security goals, and attack scenario catalogues.

8. The method of claim 1, wherein one or more determined threats are ranked based at least in part on a degree of cascading impacts of the determined threats on a subsequent stage or stages in the machine learning model's lifecycle or a presence of one or more compensating controls existing in relation to each of the said threats.

9. The method of claim 1, wherein generating the set of assumptions comprises identifying adversarial attack stages in terms of ML ATT&CK techniques and mapping the ML ATT&CK techniques to Common Vulnerabilities and Exposures (CVEs).

10. The method of claim 9, wherein mapping ATT&CK techniques to CVEs comprises computing a distance measurement between context representations in one or more CVE reports and concept representations of ATT&CK descriptions and generating a plurality of data labels for the mapping based on the computation.

11. The method of claim 1, further comprising generating a report comprising information including the one or more failure modes in the machine learning model, an effect of the one or more failure modes on a further stage in the machine learning model's lifecycle, or an adversarial context.

12. The method of claim 1, further comprising determining that a configuration of the machine learning model has been updated, and iterating the determining, generating, performing, and identifying.

13. The method of claim 1, wherein the test attack performed at least in part based on the assumptions comprises an evasion attack, an inference attack, a poisoning attack on a training dataset or a testing dataset, or a model stealing attack.

14. The method of claim 1, further comprising providing a notification at a user device in response to determining a presence of one or more failure modes in the machine learning model.

15. The method of claim 1, further comprising performing remediation step(s) on one or more features or inputs of the machine learning model based on the identified failure mode(s).

16. The method of claim 1, further comprising monitoring failure mode(s) over a period of time, identifying a pattern associated with one or more failure modes, and adjusting one or more parameters of the machine learning model based on the identified pattern.

17. A tangible, non-transitory, computer-readable media having instructions thereupon which when implemented by a processor cause the processor to perform a method for performing security evaluation on a machine learning model, comprising:
determining a taxonomy of the machine learning model and of an environment in which the machine learning model is implemented at one or more stages in a lifecycle of the machine learning model;
generating, based on the determined taxonomy, a set of assumptions about the machine learning model and the environment;
performing a first adversarial test attack on the machine learning model at a stage in the machine learning model's lifecycle, based at least in part on the set of assumptions; and
identifying one or more failure modes in the machine learning model based on a result of the first adversarial attack.

18. A system for performing security evaluation on a machine learning model, comprising:
a threat modelling component configured to determine a taxonomy of the machine learning model and of an environment in which the machine learning model is implemented at one or more stages in a lifecycle of the machine learning model, wherein the threat modelling component is further configured to generate, based on the determined taxonomy, a set of assumptions about the machine learning model and the environment;
an assessment component configured to perform a first adversarial test attack on the machine learning model at a stage in the machine learning model's lifecycle, based at least in part on the set of assumptions generated by the threat modelling component; and
wherein the assessment component is further configured to identify one or more failure modes in the machine learning model based on a result of the first adversarial attack.

19. The system of claim 18, further comprising a reporting component configured to generate a report comprising information including the one or more failure modes in the machine learning model, an effect of the one or more failure modes on a further stage in the machine learning model's lifecycle, or an adversarial context.

20. The system of claim 18, further comprising a risk mitigation component configured to remediation step(s) on one or more features or inputs of the machine learning model based on the identified failure mode(s).
